(19) United States
(12) Patent Application Publication
(10) Pub. No.: US 2023/0270128 A1
(43) Pub. Date: Aug. 31, 2023

(54) OLEOGEL

(71) Applicant: BFLIKE B.V., Elst (NL)

(72) Inventors: Michael CAMILLERI, Elst (NL); Oscar Jan HOOGLAND, Elst (NL); Wouter Matthijs FRANKEN, Elst (NL)

(73) Assignee: BFLIKE B.V., Elst (NL)

(21) Appl. No.: 18/040,592

(22) PCT Filed: Aug. 6, 2021
(86) PCT No.: PCT/NL2021/050497

§ 371 Date: Feb. 3, 2023

(30) Foreign Application Priority Data
Aug. 7, 2020 (NL) 2026242

(51) Int. Cl. A23D 7/04; A23D 7/005; A23L 29/269; A23J 3/22; A23J 3/14; A23J 3/16

(52) U.S. Cl. CPC A23D 7/04; A23D 7/0053; A23L 29/272; A23J 3/227; A23J 3/14; A23J 3/16

(57) ABSTRACT

The invention provides a method for producing an oleogel, the method comprising a mixing stage, a cross-linking stage and optionally a drying stage; wherein the mixing stage comprises mixing starting materials to provide a starting mixture, wherein the starting materials comprise (i) a hydrocolloid, (ii) a protein, (iii) one or more of a fat and an oil, and (iv) water, wherein the protein is a vegetable based protein and wherein the one or more of the fat the oil is a vegetable based; wherein the cross-linking stage comprises cross-linking the hydrocolloid and the protein in the starting mixture, to provide a cross-linked structure; and wherein the optional drying stage comprises drying the cross-linked structure to provide a further processed cross-linked structure; wherein the oleogel comprises the cross-linked structure or wherein the oleogel comprises the further processed cross-linked structure, wherein the oleogel comprises a total amount of fat and oil relative to a total amount of the oleogel in the range of 20-90 wt. %.

### FIELD OF THE INVENTION

The invention relates to oleogels, especially mimicking animal fat, a method for producing the oleogels, and food products comprising the oleogel.

### BACKGROUND OF THE INVENTION

Methods to prepare structures that mimic animal fat or adipose tissue are known. U.S. Pat. No. 5,213,829 (A) for instance describes meat products which, before and after preparation, have the aroma, appearance, and taste of meat products of a comparable character but contain substantially less cholesterol and/or saturated fats and typically retain their juiciness and taste upon standing after being cooked for a longer time than conventional meat products do. The reduced cholesterol/saturated fat content is realized by in part substituting for natural adipose an artificial adipose based on an emulsion of: (a) blood plasma, preferably from the same specie of animal as the meat from which the product is made, and (b) cholesterol-free or low cholesterol fats and oils which may also be free of saturation or have a low degree of saturation. Various agents can be employed to convert the blood plasma/lipid emulsion to a gelatinous form in which it closely resembles a natural adipose; and the adipose can be formulated so that it will become colorless as the product is prepared by cooking like natural adipose does.

### SUMMARY OF THE INVENTION

The demand of growing populations who want the taste, texture and nutrition associated with meat should preferably be balanced with the need to steward the planet for future generations. Therefore, food technology companies have made the push to develop plant-based alternatives to meat which have been shown to have a lower environmental impact than industrial livestock production. The manipulation of plant-based proteins into filamentous, myofibrillar like structures has allowed the development of lean muscle tissue analogues to make massive leaps in the last few years. This has enabled the successful production and commercialization of processed-meat products such as nuggets, burgers, and sausages. However, the development of whole-muscle analogues is still a way off. One such limitation is that the juiciness of meat analogues in not similar to that of animal tissue, an issue which is currently mitigated by the addition of unstructured fats, more water or beetroot juice.

It is however important to realize that meat is not just a bundle lean, myofibrillar proteins. It is a composite of biological tissues that each play a role in heightening sensory perception. For example, adipose tissue plays an important role in determining the juiciness and tenderness of meat when it is found intramuscularly. Fat contributes to flavor through the formation of lipid oxidation compounds and through the interaction of these lipid oxidation compounds with maillard reaction by products. Animal fat does not have one particular melting point, but a range in which different triglycerides transition from solid to liquid state.

Hence, there appears to be a need for structures that may mimic animal fat, especially structures based on ingredients of vegetable origin and even more especially substantially not comprising ingredients of animal origin.

Hence, it is an aspect of the invention to provide an alternative structure to mimic animal fat (structures), which preferably further at least partly obviates one or more of above-described drawbacks. It is a further aspect of the invention to provide a method for producing such structures, which preferably further at least partly obviates one or more of above-described drawbacks. It is yet a further aspect of the invention to provide a (vegetarian) food product comprising the structure, which preferably further at least partly obviates one or more of above-described drawbacks

The present invention may have as object to overcome or ameliorate at least one of the disadvantages of the prior art, or to provide a useful alternative.

The structures may especially comprise structured oil for the mimicry of a (animal) fat. The structures may comprise an oleogel.

Hence, in a first aspect, the invention provides a method for producing a structure to mimic animal fat. Further, especially in embodiments, the invention provides a method for producing an oleolgel. The oleogel is especially an edible oleogel. In further embodiments, the method especially comprises a mixing stage and a cross-linking stage. The method may in further embodiments also comprise (an especially optional) drying stage. The mixing stage may in specific embodiments comprise mixing starting materials to provide a starting mixture. The starting materials may especially comprise a hydrocolloid. In further embodiments, the starting materials may comprise a protein. The starting materials may further comprise water. In specific embodiments, the starting materials may (further) comprise one or more of a fat and an oil. Mixing in the mixing stage may in embodiments comprise emulsifying. In embodiments the mixing stage comprises mixing starting materials to provide a starting mixture comprising an emulsion. The cross-linking stage may in embodiments comprise cross-linking one or more of the hydrocolloid and the protein in the starting mixture, especially in the emulsion, to provide a cross-linked structure. In further embodiments the cross-linking stage comprises cross-linking the hydrocolloid and cross-linking the protein. The method may further optionally comprise a drying stage (comprising drying the cross-linked structure) to provide a further processed cross-linked structure. In further specific embodiments the fat and/or oil is vegetable based. Further, in embodiments the protein is especially vegetable based. Further, especially, the oleogel comprises the cross-linked structure or the oleogel comprises the further processed cross-linked structure. The oleogel especially comprises a total amount of fat and oil relative to a total amount of the oleogel in the range of 20-90 wt. %, especially in the range of 30-70 wt. %.

Hence, the invention provides in embodiments a method for producing an oleogel, wherein the method comprises a mixing stage and a cross-linking stage, wherein the mixing stage comprises mixing starting materials to provide a starting mixture comprising an emulsion, wherein the starting materials comprise (i) a hydrocolloid, (ii) a protein, (iii) one or more of a fat and an oil, and (iv) water, wherein the protein is a vegetable based protein and wherein the one or more of the fat the oil is a vegetable based (the fat is a vegetable based fat and the oil is a vegetable based oil—if present); wherein the cross-linking stage comprises cross-linking one or more of the hydrocolloid and the protein, especially (both) the hydrocolloid and the protein, in the starting mixture, to provide a cross-linked structure; wherein the method further optionally comprises a drying stage, comprising drying the cross-linked structure, to provide a further processed cross-linked structure; wherein the oleogel comprises the cross-linked structure or the oleogel comprises the further processed cross-linked structure; wherein the oleogel comprises a total amount of fat and oil relative to a total amount of the oleogel in the range of 20-90 wt. %.

Based on this method, structures may be produced that mimic animal fat, while especially not comprising animal ingredients. The structures may have comparable properties to animal fat. The structures especially may maintain their shape when being heated. The structures may turn brown when being heated/cooked. The structures may provide the desired juiciness to meat analogs.

Herein, in embodiments, structures are described comprising structured oil for the mimicry of a (animal) fat. Especially, embodiments of structuring of lipids by means of plant or microbially derived polymers are described. The structures may comprise oleogels or double emulsion gels.

Oleogels may especially be gels in which the continuous liquid phase is oil. The term “oleogel” especially relates to an “organogel” or “double emulsion gel”. Oleogels are novel structures for forming oils into gel-like structures. The oil may especially be comprised in a three-dimensional cross-linked network.

The method may especially comprise a mixing stage and a cross-linking stage. The method may further optionally comprise a drying stage.

In embodiments, the mixing stage especially comprises mixing starting materials to provide a starting mixture, wherein the starting materials comprise (i) a hydrocolloid, (ii) a protein, (iii) one or more of a fat and an oil, and (iv) water.

In further embodiments, the starting materials may be added and mixed sequentially. In embodiments, e.g., first the hydrocolloid, the protein and (at least part of) the water is mixed (optionally with further ingredients, see below), especially in an initial mixing stage. In further embodiments, the fat and/or oil may be added and mixed in the starting mixture. The mixing stage may in further embodiments comprise emulsifying, especially emulsifying one or more of a fat and an oil into the starting mixture (to provide an emulsion). Hence, in further specific embodiments, the method may further comprise an emulsification stage. Further, especially the emulsification stage may comprise emulsifying one or more of a (the) fat and an (the) oil into the starting mixture (to provide an emulsion). The emulsification stage may be comprised by the mixing stage. In embodiments, the mixing stage comprises an initial mixing stage and an emulsification stage (subsequent to the initial mixing stage).

The initial mixing stage may comprise mixing the hydrocolloid, the protein and (the) water to provide an initial starting mixture.

In embodiments, the hydrocolloid, the protein and (at least part of) the water is mixed (in the initial mixing stage), especially providing an initial starting mixture. Mixing may in embodiments be performed at room temperature. Yet, in further embodiments these starting materials may be mixed at any arbitrary temperature. In embodiments, the emulsification stage may comprise heating the (initial) starting mixture (especially to prevent solidification of the fat and/or oil). Heating the mixture may in embodiments be performed before and/or during and/or after emulsifying the fat and/or oil into the mixture. The mixture may in embodiments be heated to a temperature up to 95° C., especially to a maximum of 90° C., or to a maximum of 80° C., especially to at least 50° C. The one or more of the fat and the oil (herein also indicated as “one or more of the fat and oil”, or simply “fat and/or oil” or “fat/oil”) may further especially be liquefied before emulsifying it into the starting mixture. The fat and/or oil may be heated before adding it to the (initial) starting mixture. In embodiments, a temperature during emulsifying the one or more of the fat and the oil into the starting mixture may be 95° C. at maximum, especially 90° C. at maximum, such as 80° C. at maximum. The temperature may be at least 20° C., especially at least 40° C., even more especially at least 50° C. The temperature may e.g. be in the range of 20-95° C., such as in the range of 60-95° C., especially in the range of 80-95° C. The phrase “emulsifying the fat/oil into the starting mixture” and comparable phrases may especially indicate that the fat/oil is mixed with the other ingredients (in the initial starting mixture) to provide the starting mixture, especially wherein the starting mixture comprises an emulsion (during and especially at the end of the emulsifying). Further, the term “emulsion” especially indicates a mixture of at least two liquid phases, wherein one phase is a continuous phase, and another phase is dispersed in the continuous phase.

In further embodiments, the method may comprise a setting stage. The setting stage may especially comprise setting the starting mixture, especially the emulsion, especially into a (stage one) gel. The setting stage may comprise cooling the starting mixture, especially the emulsion, especially to provide a set starting mixture. The starting mixture, especially the emulsion, may be cooled to a setting cooling temperature. The setting cooling temperature may in embodiments be lower than 50° C., such as 40° C. at maximum, especially 30° C. at maximum, or e.g., at room temperature. The starting mixture or emulsion may in embodiments be cooled in a mold. The setting stage may therefore herein also be referred to as “molding stage”. Moreover, the setting stage may comprise molding and setting the starting mixture. The term “molding” especially refers to providing (the starting mixture) into a mold. Further, the starting mixture after setting in the setting stage may herein also be referred to as “a set starting mixture” or a “stage one gel”.

Hence, in further embodiments, the setting stage comprises cooling the starting mixture to a setting cooling temperature to provide a set starting mixture.

The setting stage is in embodiments configured between the mixing stage and the cross-linking stage.

Optionally, the method may further comprise a cutting stage for reducing a size of the stage one gel provided in the setting stage. In the cutting stage, a dimension of the set starting mixture, (or stage one gel) may be reduced to basically any desired size. The dimensions may especially be selected based on a type of animal fat to mimic. For instance, in embodiments, the dimension (such as one or more of a height, width, length, or diameter) may be reduced to equal to or smaller than 10 mm, especially equal to or smaller than 5 mm, such as to about 1 mm. In further embodiments the dimension may be reduced to equal to or smaller than 10 cm, such as equal to or smaller than 5 cm, e.g., to 0.5-5 cm, especially 1-5 cm, or especially 0.5-2 cm.

In further embodiments, the cutting stage may comprise reducing a dimension of the set starting mixture, wherein the dimension is reduced to equal to or smaller than 10 mm, especially equal to or smaller than 5 mm, such as to about 1 mm. In further embodiments (of the cutting stage), the dimension may be is reduced to equal or smaller than 10 cm, such as equal to or smaller than 5 cm, e.g., to 0.5-5 cm, especially 1-5 cm, or especially 0.5-2 cm. equal to or smaller than 10 mm, such as equal to or smaller than 5 mm, e.g., to 1-5 mm, especially to about 1 mm, even more especially to equal to or smaller than 1 mm, such as to about 0.5 mm, or about 0.1 mm. In yet further embodiments, the dimension may be reduced to equal to or smaller than 30 cm, such as equal to or smaller than 20 cm, especially equal to or smaller than 10 cm.

The term “dimension” may especially refer to one or more of a height, width, length, or e.g. diameter.

Especially, after setting and optionally cutting, the starting mixture, especially the stage one gel, may be further gelled by cross-linked in the cross-linking stage.

The cross-linking stage especially comprises cross-linking one or more of the hydrocolloid and the protein in the starting mixture, especially in the stage one gel, to provide a cross-linked structure. Further, the optional drying stage especially comprises drying the cross-linked structure (especially, to reduce a total amount of water in the cross-linked mixture) to provide a further processed cross-linked structure. The oleogel especially comprises the cross-linked structure or the further processed cross-linked structure. Further the oleogel especially comprises a total amount of fat and oil relative to a total amount of the oleogel in the range of 20-90 wt. %, especially in the range of 30-70 wt. %. In embodiments, the drying stage is performed on the cross-linked structure. In this stage, an excess of water may be removed from the cross-linked structure to obtain the further processed structure. The starting material may thus comprise a larger relative amount of water compared to the resulting oleogel. In embodiments, the starting mixture comprises an emulsion and/or an emulsion appearance. Mixing in the mixing stage may comprises emulsifying, especially under high shear. In further embodiments, the method, especially the mixing stage, further comprises an emulsifying stage.

Hence in embodiments, the cross-linking stage comprises one or more of (i) cross-linking the hydrocolloid and (ii) cross-linking the protein. In further specific embodiments, the cross-linking stage comprises (i) cross-linking the hydrocolloid (with a hydrocolloid cross-linker) and (ii) cross-linking the protein. In embodiments, cross-linking the hydrocolloid and cross-linking the protein are performed simultaneously. In further embodiments, these two cross-linking reactions are performed at least partly sequentially. In embodiments, the cross-linking stage may comprise: starting cross-linking the hydrocolloid and successively cross-linking the protein. In further embodiments, the cross-linking stage comprises: adding one or more cross-linking components for cross-linking one or more of (i) the hydrocolloid and (ii) the protein. In embodiments, the cross-linking stage comprises: adding a salt to the starting mixture, especially wherein the salt comprises one or more cations from the group consisting of (i) calcium, (ii) potassium, (iii) sodium, and (iv) magnesium, even more especially wherein the salt comprises CaCl₂. Cross-linking the hydrocolloid is especially performed using a hydrocolloid cross-linker. Cross-linking the hydrocolloid especially comprises cross-linking the hydrocolloid with a hydrocolloid cross-linker. The cross-linking stage may in further embodiments comprise providing a hydrocolloid cross-linker to the starting mixture, especially for cross-linking the hydrocolloid (in the starting mixture).

Hence, the hydrocolloid cross-linker may comprise a salt, such as described above. In further embodiments the hydrocolloid cross-linker may comprise sugar.

In further embodiments, the cross-linking stage comprises: adding a cross-linking enzyme to the starting mixture, especially wherein the cross-linking enzyme comprises transglutaminase. Cross-linking the protein is in embodiments performed using the cross-linking enzyme. The cross-linking enzyme may especially comprise transglutaminase. Transglutaminase may especially be a microbial transglutaminase, which may also be indicated as mTGase, mTgase, or e.g. mTG.

Cross-linking the protein especially comprises cross-linking the protein with a (protein) cross-linking enzyme. The cross-linking stage may in further embodiments comprise providing a (protein) cross-linking enzyme to the starting mixture especially for cross-linking the protein (in the starting mixture). In further specific embodiments, the cross-linking stage may comprise providing a hydrocolloid cross-linker and a (protein) cross-linking enzyme to the starting mixture, especially for cross-linking the hydrocolloid and the protein (in the starting mixture).

The cross-linker is in further embodiments added to the starting mixture, especially to the stage one gel, by diffusion. In embodiments, the cross-linker is mixed with an aqueous solvent, especially water, to provide a cross-linker solution. The stage one gel is especially covered with the cross-linker solution. The stage one gel may be immersed in the cross-linker solution. The cross-linking stage may in further embodiments comprise contacting the starting mixture, especially the stage one gel, with a cross-linker solution, wherein the cross-linker solution comprises the cross-linker. The cross-linker especially comprises the cross-linking enzyme and especially also the hydrocolloid cross-linker. The cross-linking stage may in further embodiments comprise diffusing the cross-linker (especially the cross-linking enzyme and especially also the hydrocolloid cross-linker) in the starting mixture, especially the stage one gel, especially to cross-link the protein and especially (also) the hydrocolloid, to provide the cross-linked structure, especially comprising a stage two gel. In embodiments, contacting the starting mixture, especially the stage one gel with a cross-linker solution may refer to immersing the stage one gel in the cross-linker solution. Especially, contacting the starting mixture with the cross-linker solution may comprise immersing the starting mixture in the cross-linker solution.

Herein the term “cross-linker” may refer to the cross-linking enzyme. The term may further refer to the hydrocolloid cross-linker. The term may refer to a plurality of different cross-linkers, e.g. (a combination of) the hydrocolloid cross-linker and the cross-linking enzyme. The term “cross-linking enzyme” especially relates to a protein cross-linking enzyme. The protein cross-linking enzyme may in embodiments provide cross-links between and within the protein(s). The protein cross-linking enzyme may in further embodiments (also) provide cross-links between the protein and further ingredients, such as e.g. the hydrocolloid. Likewise, the hydrocolloid cross-linker especially provides cross-links between hydrocolloid(s) molecules and with hydrocolloid(s) (molecules). The hydrocolloid cross-linker may in further embodiments (also) provide cross-links between the hydrocolloid and further ingredients, such as e.g. the protein.

The cross-linker may especially diffuse from the cross-linker solution into the starting mixture, especially into the stage one gel. Based on the diffusion the cross-linking may start, especially from an outer surface of the stage one gel and (slowly) proceed to a center of the stage one gel. Hence, herein terms like “adding” in relation to the cross-linker, in phrases like “adding the cross-linker to the starting mixture” may, in embodiments, refer to contacting the starting mixture, especially the stage one gel with the cross-linker solution, and or diffusing the cross-linker in the starting mixture (stage one gel).

The cross-linking stage may in further embodiments comprise contacting the starting mixture, especially the stage one gel, with the cross-linker solution during a cross linking incubation period.

In embodiments, the cross-linking stage comprises: maintaining a temperature of the starting mixture, especially of the stage one gel, at an incubating temperature during a cross-linking incubation period, especially wherein the incubating temperature is equal to or lower than 60° C., especially the incubating temperature is selected from the range of 5-45° C., such as 20-40° C. In further embodiments, the incubation temperature is selected from the range of 30-65° C., such as in the range of 40-60° C., even more especially in the range of 50-60° C.

In embodiments, the cross-linking incubation period is 10 min-6 hours, especially 30 min-4 hours, such as 1-3 hr.

In further embodiments, the cross-linking stage comprises: a first incubating stage at a first incubating temperature and a second incubating stage at a second incubating temperature, wherein the first incubating temperature is selected from the range of 3-25° C., and wherein the second incubating temperature is selected from the range of 20-45° C., especially wherein (i) the first incubating stage is configured before the second incubating stage or (ii) the first incubating stage is configured after the second incubating stage.

In further embodiments, the mixing stage, especially the emulsification stage comprises: mixing the starting materials at a temperature in the range of 60-95° C.

In further embodiments, the protein is a plant-based protein. The protein may e.g. comprise pea protein. The protein may comprise soy protein. The protein may in embodiments comprise lupine protein. In further embodiments, the protein may comprise chickpea protein. The protein may further comprise wheat protein. The protein may comprise oat protein. Additionally or alternatively, the protein may comprise potato protein and/or flax protein. The protein may comprise hemp protein and/or corn protein. The protein may also comprise barley protein and/or rye protein. In even further embodiments, the protein may comprise bean protein and/or navy bean protein and/or faba bean protein. Further examples of the protein may e.g. comprise spirulina protein and/or canola protein and/or mung bean protein. The protein may comprise algae protein (or algal protein).

Additionally or alternatively, the protein may comprise rice protein. The protein may in further embodiments comprise a fungal protein, such as mycoprotein (especially produced by fermentation). In further embodiments, the protein may comprise a yeast protein (especially a microbial yeast protein). In yet further embodiments, the protein comprises duckweed protein.

Herein the terms “vegetable based” and “plant based” may be used interchangeably. The terms in relation to an ingredient especially indicate that the vegetable based ingredient is harvested extracted or e.g. produced from plant or vegetable raw material and especially not from animal raw material. The term may in further embodiments refer to protein originating from yeast, fungi, or see vegetables.

The term “protein” may refer to a plurality of different proteins, especially one or more described herein. The term may especially refer to an isolate of the protein. The protein especially comprises a (plant-based) protein isolate.

Hence, in further embodiments, the protein comprises one or more proteins of the group consisting of (i) pea protein, (ii) soy protein, (iii) lupine protein, (iv) chickpea protein, (v) wheat protein, (vi) oat protein, (vii) potato protein, (viii) flax protein, (ix) hemp protein, (x) corn protein, (xi) barley protein, (xii) rye protein, (xiii) bean protein, (xiv) spirulina protein, (xv) canola protein, (xvi) faba bean protein, and (xvii) mung bean protein, (xviii) navy bean protein, (xiv) rice protein, (xv) mycoprotein, and (xvi) algae protein, especially one or more of the group consisting of (i) pea protein, (ii) soy protein, (iii) lupine protein, (iv) or chickpea protein, especially pea protein. The protein may especially be provided in a form of a protein isolate.

The starting materials may especially comprise a protein isolate of the proteins described herein.

In further embodiments, the oil and/or fat are from vegetable origin. An unlimited list of possible fats and oils comprises e.g. palm fat, coconut fat, cacao fat, sunflower oil, olive oil, rapeseed oil, soy oil, peanut oil, and rice bran oil. The fat and/or oil may comprise one or more of the group consisting of (i) palm fat, (ii) coconut fat, (iii) cacao fat, (iv) sunflower oil, (v) olive oil, (vi) rapeseed oil, (vii) soy oil, (viii) peanut oil, and (ix) rice bran oil. The fat may comprise a hydrogenated oil. The oil especially comprises sunflower oil or rapeseed oil. The fat especially comprises palm fat or coconut fat. The terms “fat and “oil” may refer to a plurality of different fats and oils, respectively.

In further embodiments, the hydrocolloid is from vegetable origin. The hydrocolloid may e.g. comprise gellan gum. The hydrocolloid may comprise agar agar. In further embodiments, the hydrocolloid may comprise xanthan (gum). In yet further embodiments, the hydrocolloid may further comprise pectin and/or gelatin. In further embodiments, the hydrocolloid may comprise sodium alginate and/or carboxy methyl cellulose (“CMC”). Additionally or alternatively, the hydrocolloid may comprise methyl cellulose. Further examples of possible hydrocolloids are e.g. locust bean gum, flaxseed gum, guar gum, and gum Arabic. The hydrocolloid may in further embodiments (further) comprise one or more of these gums. The term “hydrocolloid” may especially refer to a plurality of different hydrocolloids.

In further embodiments, the hydrocolloid comprises one or more of the group consisting of (i) gellan gum, (ii) agar agar, (iii) xanthan, (iv) pectin, (v) sodium alginate, (vi) gelatin, (vii) locust bean gum, (viii) flaxseed gum, (ix) guar gum, (x) carboxy methyl cellulose, (xi) gum Arabic, (xii) carrageenan, and (xiii) methyl cellulose. The hydrocolloid may especially comprise one or more of (low methoxyl) pectin, gellan, alginate, kappa carrageenan, or iota carrageenan.

In further embodiments, a total weight of the hydrocolloid in the starting mixture is selected in the range of 0.01-15 wt. %, especially 0.01-10 wt. % or especially 0.1-15 wt. %, such as 0.01-5 wt. %, especially in the range of 0.1-3 wt. %, more especially 0.2-2 wt. % relative to a total weight of the starting mixture. The total weight of the hydrocolloid in the starting mixture is in embodiments selected in the range 0.3-0.6 wt. % relative to a total weight of the starting mixture. In further embodiments, a total weight of the hydrocolloid in stage one gel is selected in the range of 0.01-15 wt. %, especially 0.01-5 wt. % or especially 0.1-15 wt. %, such as in the range of 0.1-3 wt. %, more especially 0.2-2 wt. % relative to a total weight of the stage one gel. The total weight of the hydrocolloid in the stage one gel is in embodiments selected in the range 0.3-0.6 wt. % relative to a total weight of the stage one gel.

Further, a total weight of protein (especially of the protein isolate) in the starting mixture may be selected in the range of 0.5-25 wt. %, especially 0.5-10 wt. %, such as 1-10 w.t %, especially 1-5 wt. % relative to a total weight of the starting mixture

In further embodiments, the starting mixture comprises (i) gellan gum, (ii) pea protein isolate, and (iii) one or more of a fat and an oil; especially wherein in the cross-linking stage CaCl₂ and transglutaminase are being added. Especially the hydrocolloid comprises, especially substantially is, a gellan gum. Especially, at least 50 wt %, such as substantially all, of the protein comprises pea protein (isolate). Further, especially, the gellan gum comprises: low-acyl gellan gum and high-acyl gellan gum, wherein a weight ratio of the low-acyl gellan gum to the high-acyl gellan gum is selected from the range of 1:10-10:1, especially 1:5-5-1, such as 1:2-2:1, especially 1:1.5-1.5:1, such as 1:1.2-1.2:1. In further specific embodiments the weight ratio low-acyl gellan gum to the high-acyl gellan gum is in the range of 10:1-5:1.

The terms “low-acyl gellan (gum)” and “high-acyl gellan (gum)” are known to the skilled person. Gellan gum is especially a high-molecular-weight extracellular polysaccharide produced from the fermentation of a carbohydrate especially by strains of Pseudonzonas elodea. In the native or high-acyl (“HA”) form two acyl substituents, acetate and glycerate, are present. Both substituents are located on the same glucose residue and, on average, there is one glycerate per repeat unit and one acetate per every two repeat units. In the low-acyl (“LA.”) form, most of the acyl groups have been removed to produce a linear repeat unit substantially lacking such groups. High-acyl gellan gum is also called HA Gellan gum and especially comprises a degree of acylation over 50%; (and having a total acyl content over 7.35 wt %). Further, Low-acyl gellan (gum) is also called LA Gellan gum and especially comprises a degree of acylation of equal to or smaller than 50% (and having a total acyl content equal to or less than 7.35 wt %). The purification process is different for the various types of gellan gum: HA Gellan gum is directly recovered from broth by alcohol precipitation, whereas for LA Gellan gum the broth may first treated with alkali before the alcohol precipitation, or gellan may further be deacylated to provide the low-acyl gellan gum. Based on these steps also the molecular weights and gelling temperature may differ, being about 1-2*106 and 70-80° C. for HA Gellan gum, and 2-3*105 and 10-60° C. for LA Gellan gum.

In further embodiments, the starting mixture comprises (i) gellan gum, (ii) pea protein isolate, and (iii) sunflower oil; wherein in the cross-linking stage CaCl₂ and transglutaminase are being added; wherein the gellan gum comprises: low-acyl gellan gum and high-acyl gellan gum.

In further embodiments, the starting materials may further comprise a (metal) sequestering agent. The sequestering agent may support processibility of the hydrocolloid. The term “sequestering agent” especially refers to any agent complexing, chelating or sequestering bivalent ions such as calcium or magnesium. The sequestering agent may in embodiments comprise one or more of a citrate and a chlorate, especially sodium citrate and sodium chloride. In further embodiments, the sequestering agent comprises a calcium citrate and/or a calcium chlorate. The sequestering agent is especially a metal salt. In embodiments, the sequestering agent may further be selected from the group comprising trisodium citrate, trisodium phosphate, tetrasodium pyrophosphate, sodium hexametaphosphate and mixtures thereof.

Hence, the starting materials may further comprise a sequestering agent. The sequestering agent may in embodiments be mixed with the other ingredients in the mixing stage. The sequestering agent is especially mixed in the initial mixing stage (with the further ingredients). In embodiments, the initial starting mixture may comprise a sequestering agent. Further, especially, the initial mixing stage may comprise mixing the hydrocolloid, the protein, the sequestering agent and the water to provide the initial starting mixture.

In embodiments, the one or more of the fat and the oil comprises sunflower oil, and especially (also) coconut fat.

In further embodiments, in the cross-linking stage CaCl₂ and transglutaminase are added.

In further specific embodiments, the method may comprise the stages of:
mixing the hydrocolloid with water to provide an aqueous hydrocolloid;
mixing the protein with water to provide an aqueous protein;
providing a liquid fat and/or oil; optionally by liquifying the fat and/or oil, especially by selecting a temperature to liquify the fat;
mixing a hydrocolloid cross-linker with water to provide an aqueous hydrocolloid cross-linker;
mixing a (protein) cross-linking enzyme with water to provide an aqueous protein cross-linking enzyme;
emulsifying the liquid fat and/or oil with the aqueous protein to provide a first emulsion
adding the aqueous hydrocolloid cross linker and (successively) the aqueous protein cross-linking enzyme to the first mixture to provide a second mixture
setting and/or crosslinking the second mixture at a temperature in the range of 0-40° C., especially 0-20° C., such as 0-5° C., and especially in a mold to provide a first structure.
maintaining a temperature of the first structure at a further incubating temperature during a further incubating period (until a desired degree of cross-linking is obtained), wherein the incubating temperature is equal to or lower than 60° C., especially equal to or lower than 45° C., such as equal to or lower than 40° C. to provide a further structure, especially wherein the further incubating period is in the range of 10 min-5 hours, especially 30 min-4 hours, such as 1-3 hours, or especially no more than 2 hours; and
optionally drying the further structure to provide the oleogel.

In embodiments, one or more, especially all of the stages (i) mixing the hydrocolloid with water, (ii) mixing the protein with water, (iii) mixing the hydrocolloid cross-linker with water, (iv) mixing the (protein) cross-linking enzyme with water, (v) emulsifying the liquid fat and/or oil with the aqueous protein (vi) and adding the aqueous hydrocolloid cross linker and (successively) the aqueous protein cross-linking enzyme comprise high shear mixing.

Further, especially during mixing the hydrocolloid with water, a temperature of the mixture may be maintained in the range of 60-95° C., especially in the range of 85-95° C. (especially for the hydrocolloid comprising gellan gum). In embodiments, one or more of (i) mixing the protein with water and (ii) mixing the protein cross-linking enzyme with water, and (iii) mixing the hydrocolloid cross-linker with water comprises maintaining a temperature of said mixture at room temperature. Further, especially adding the aqueous hydrocolloid cross linker to the first mixture may comprise maintaining said mixture at a temperature of 60-95° C. In embodiments, adding the aqueous protein cross-linking enzyme to the first mixture comprises maintaining said mixture at a temperature of equal to or lower than 60° C., especially in the range 55-60° C.

In a further embodiment the mixing stage comprises:
mixing (blending) water, the sequestering agent, the protein and the hydrocolloid, especially at an initial mixing temperature and especially during an initial mixing period to provide the initial starting mixture,
heating the initial starting mixture to an initial starting mixture temperature, emulsifying the one or more of the fat and oil into the initial starting mixture,
especially at an emulsification temperature and especially during an emulsification period, to provide the starting mixture, especially wherein the starting mixture comprises an emulsion;

Hence the mixing stage may in embodiments comprise the initial mixing stage prior to the emulsification stage. The initial mixing stage may especially comprise: mixing (blending) water, the sequestering agent, the protein, and the hydrocolloid, especially at an initial mixing temperature and especially during an initial mixing period to provide the initial starting mixture to provide the initial starting mixture. In further embodiments, the initial mixing stage may further comprise heating the initial starting mixture to an initial starting mixture temperature.

The emulsification stage may, in embodiments, comprise emulsifying the one or more of the fat and oil into the initial starting mixture, especially at an emulsification temperature and especially during an emulsification period, to provide the starting mixture, especially wherein the starting mixture comprises an emulsion.

The initial mixing temperature may in embodiments be room temperature (especially about 20° C.). The initial temperature may in further embodiments especially be above 0° C., and especially below 95° C., such as in the range of 2-90° C., especially 5-60° C., such as 5-40° C., such as 10-30° C. The initial mixing period may be at least a few seconds, such as at least 10 seconds, especially at least 30 seconds, such as at least 1 minute. Essentially the initial mixing period may be hours. Yet, practically, the maximum initial mixing time is equal to or less than 60 min, such as equal to or less than 30 min., especially equal to or less than 10 min.

In further specific embodiments, the sequestering agent may be mixed with part of the water providing a first aqueous mixture, and the hydrocolloid and the protein may separately be mixed with the remainder of the water providing a second aqueous mixture, and successively the first and second aqueous mixtures are mixed or blended. The mixing or blending of the first and second aqueous mixtures may be performed at a temperature as described in relation to the initial mixing temperature. The mixing or blending of the first and second aqueous mixtures may, in embodiments, be performed during a period as described in relation to the initial mixing period.

In further embodiments, the method comprises the initial mixing stage, the emulsification stage, the setting stage, (optionally the cutting stage,) and the incubation stage.

In specific embodiments, the method may comprise:
mixing (blending) water, the sequestering agent, the protein, and the hydrocolloid, especially at an initial mixing temperature and especially during an initial mixing period to provide the initial starting mixture,
heating the initial starting mixture to an initial starting mixture temperature,
emulsifying the one or more of the fat and oil into the initial starting mixture, especially at an emulsification temperature and especially during an emulsification period, to provide the starting mixture, especially wherein the starting mixture comprises an emulsion;
setting the starting mixture, especially the emulsion, into a stage one gel, especially wherein the starting mixture is provided in a mold, especially wherein the starting mixture is cooled to the setting cooling temperature;
providing an aqueous solvent, especially water, comprising the cross-linker, especially the cross-linking enzyme and the hydrocolloid cross-linker (such as transglutaminase and calcium chloride),
contacting the starting mixture, especially the stage one gel, with the cross-linker solution, wherein the cross-linker solution comprises the cross-linker, especially diffusing the cross-linker in the starting mixture, to provide the cross-linked structure, especially comprising a stage two gel.

Further, especially contacting the starting mixture, especially the stage one gel, with the cross-linker solution, is performed during the incubation period, especially at the incubating temperature.

In further embodiments, the cross-linked structure is separated from the cross-linker solution. The provided cross-linker structure may further be stores in a cold store.

In further embodiments, after setting the starting mixture and prior to cross-linking, the set starting mixture, is cut in the cutting stage. The cutting stage may in embodiments be configured between the setting stage and the cross-linking stage.

The invention further provides an oleogel comprising an oil and fat content in the range of 20-90 wt. %, especially in the range of 30-70 wt. %. The oleogel may especially be provided with the method of the invention. The oleogel is especially thermally stable. The term “thermally stable” may indicate that the oleogel may not or only partly melt when being heated such as pan fried. The oleogel especially does not completely disintegrate when being heated, such as to a temperature up to 200° C. The oleogel especially does not substantially change in shape when being cooked (or fried). In embodiments, the term may imply that the oleogel wherein the oleogel substantially maintains its shape when being heated to a temperature of 100° C., during for instance 30 minutes or less. In further embodiments, the shape is substantially maintained during heating the oleogel up to browning (as a result of Maillard reactions) of the oleogel. Especially, a size or dimension of the oleogel may change less than 20% during such heating to 100° C. or during heating to a temperature to start the Maillard reaction. Browning of the oleogel may in embodiments, e.g., comprise pan frying for at least 5 minutes, e.g. at a temperature of at least 140° C., such as at least 160° C. Especially, “thermally stable” may indicate that in embodiments, the oleogel may be heated at 140° C. during 5 minutes, wherein the size or dimension may change less than 20%.

In embodiments, the oleogel comprises fat and/or oil and a cross-linked protein and a hydrocolloid, especially a cross-linked hydrocolloid.

In further embodiments, the oleogel comprises 0.5-25 wt. % protein and 0.1-15 wt. % hydrocolloid (relative to a total weight of the oleogel), especially 1-10 wt. % protein and 0.25-5 wt. % hydrocolloid, even more especially 0.5-3 wt. % hydrocolloid.

In further embodiments, the fat and/or oil (“fat/oil”) is vegetable based, and especially the protein is vegetable based.

In further specific embodiments, the oleogel comprises a cross-linked protein and a cross-linked hydrocolloid, and one or more of a fat and oil, wherein the protein is vegetable based and wherein the one or more of the fat and oil is vegetable based, wherein the oleogel comprises an oil and fat content in the range of 20-90 wt. %, especially wherein the oleogel is thermally stable.

In further embodiments, the oleogel comprises gellan gum (“gellan”), and especially pea protein isolate. The gellan gum especially comprises low-acyl gellan gum and high-acyl gellan.

The oleogel may especially be applied in a food product. The oleogel may mimic animal fat, especially in a food product.

Hence, the invention further provides a food product comprising the oleogel. In embodiments, the food product is a (vegetarian) meat analog. In further specific embodiments, the food product is a vegan analog for meat (or meat analog).

The term “plurality” refers to two or more. Furthermore, the terms “a plurality of” and “a number of” may be used interchangeably

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” includes also embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. In embodiments, the system comprises the control system. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

In further specific embodiments, the invention provides a method for producing an oleogel, the method comprising a mixing stage, a cross-linking stage and optionally a drying stage; wherein the mixing stage comprises mixing starting materials to provide a starting mixture, wherein the starting materials comprise (i) a hydrocolloid, (ii) a protein, (iii) one or more of a fat and an oil, and (iv) water, the cross-linking stage comprises cross-linking one or more of the hydrocolloid and the protein in the starting mixture, to provide a cross-linked structure, and the optional drying stage comprises drying the cross-linked structure to provide a further processed cross-linked structure, wherein the oleogel comprises the cross-linked structure or wherein the oleogel comprises the further processed cross-linked structure, wherein the oleogel comprises a total amount of fat and oil relative to a total amount of the oleogel in the range of 20-90 wt. %, especially in the range of 30-70 wt. %.

In yet further specific embodiments, the invention may provide a method for producing an oleogel, the method comprising a mixing stage, an emulsification stage, a setting stage, a cross-linking stage and optionally a drying stage; wherein the mixing stage comprises mixing starting materials to provide a starting mixture, wherein the starting materials comprise (i) a hydrocolloid, (ii) a protein, and (iii) water, the emulsification stage comprises emulsifying one or more of a fat and an oil into the starting mixture (to provide an emulsion), the setting stage comprises setting the starting mixture, especially the emulsion, into a (stage one) gel, the cross-linking stage comprises cross-linking the (stage one) gel to provide a cross-linked structure, and the optional drying stage comprises drying the cross-linked structure to provide a further processed cross-linked structure; wherein the oleogel comprises the cross-linked structure or wherein the oleogel comprises the further processed cross-linked structure, wherein the oleogel comprises a total amount of fat and oil relative to a total amount of the oleogel in the range of 20-90 wt. %, especially in the range of 30-70 wt. %.

### EXPERIMENTAL

### Initial Experiments

### 1. Benchmarking the Mechanical Properties of Beef Adipose Tissue

Beef adipose tissue is composed of adipocytes (fat cells) set in a collagenous extracellular matrix. The extra cellular matrix is susceptible to thermal degradation which alters the microstructure of the tissue. In turn, changes to the microstructure of the tissue impact the visual, textural and fat-release mechanisms of the adipose tissue. It would then become apparent that the culinary mimicry of adipose tissue would require study of its mechanical properties. Thus, the aim of this experiment is to study the mechanical, culinary and visual properties of beef adipose tissue during different stages of treatment.

### Materials and Methods

Beef rib fat was purchased from a local supplier. The fat was cut into 2 cm³ pieces and vacuum sealed. The fat was then cooked in water bath at 70° C. for 16 hours. Following the cooking procedure, the samples were then removed and cooled in a water bath at 20° C. for 1 hour. Texture profile analysis (TPA) was performed on the samples at different states of thermal treatment. One sample was tested without any thermal treatment (raw, 20° C.), one was tested cooked and served at room temperature (cooked, 20° C.) and the other cooked and analyzed at serving temperature (cooked, 55° C.). Prior to testing, the “cooked, 55° C.” sample was warmed to 55° C. by placing it into a bag, vacuum sealing it and warming it in a water bath set to 55° C.

### Results

The mechanical properties of beef rib fat were analyzed by TPA and the most pertinent changes in the mechanical properties of the sample are discussed Cooking resulted in a decrease of the stiffness (modulus) from 15.26 Pa (±0.65) to 10.92 Pa (n.d.) and a reduction in the hardness from 69.53N (±11.13) to 22.36N (n.d.). Stiffness and hardness were affected by the temperature at which TPA compression was applied. At 55° C., the stiffness of the cooked sample decreased from 10.92 Pa (n.d.) to 0.154 Pa (±0.04) and the hardness from 22.36N (n.d.) to 4.29N (±0.22°) C.

The results of the first compression of the beef rib fats at 20 and 55° C. show a longer elastic period for the 20° C. sample compared to the 55° C. sample which shows nearly no elastic behavior. On fracture, the 20° C. sample shows large peaks and troughs during the plastic flow period. On comparison, at 55° C. the sample has many smaller disturbances along its plastic behavior. At 20° C., the beef adipose tissue hardness does not increase past 22N on additional strain. The opposite behavior can be seen in the 55° C. sample where increasing strain results in increasing amounts of resistance.

The raw beef rib fat had a waxy, flaky and opaque appearance. Though the beef rib fat appeared to be homogenous, further examination revealed it to be formed of a composite of adipose tissue structures. After cooking and cooling to 20° C., no change to the visual appearance of the adipose tissue could be seen. On heating to 55° C., the opacity of the adipose tissue increased. Pan searing of the 20° C. adipose tissue caused a number of changes to its visual appearance. A thin, crisp film appeared on the tissue where it had been in contact with the surface of the pan. The opacity of the beef rib fat increased as heat was added. A portion of the beef fat leaked from the sample during pan searing. However, the overall structure of the sample was maintained.

### Discussion

Results of the mechanical properties of the beef adipose tissue samples present some insights into what direction to take when simulating the product. Firstly, it is clear that cooking the adipose tissue has a large impact on the mechanical properties. These changes to the mechanical properties as a result of cooking may relate to the denaturation and solubilization of the collagenous matrix surrounding the adipocytes. The partial solubilization of collagen may cause a decrease in the strength of the matrix, leaving behind the insoluble collagen. It would then appear that the insoluble collagen may be sufficient to maintain the structure of tissue, even when the fat is in a liquid state.

Directly mimicking the solubilization behavior of collagen presents an interesting challenge for its mimicry. Designing for the uncooked adipose tissue would mean creating a material that requires a large energy input, in the form of thermal energy from cooking, to make it palatable. Rather, it would be beneficial to have the material transition from an unpalatable to a palatable state over a short time and temperature period. Engineering the material in such a manner would allow it to maintain its mechanical strength at low temperatures but reduce it as the temperature increases. This would allow traditional culinary processes (e.g. cutting, grinding) to take place as is the case with beef adipose.

The relationship between palatability and temperature can be seen by the response of the adipose tissue to uniaxial compression. As can be seen during the first compression measurement, there is a marked difference during the plastic flow period when the beef adipose tissue is measured at 20° C. or at 55° C. At 20° C., beef fat is solid while at 55° C. the lipids may have lost their crystal structure and become liquid. This change is perhaps what is causing the difference in the mechanical response. At 20° C., the solid material fractures, reducing its ability to resist mechanical pressure. At 55° C., the liquid fat is released from the matrix and solidifies as it cools. This allows it to solidify around the sample, causing an increase in resistance to deformation as the strain increases. From a culinary point of view, the serving temperature is important in this sense as the liquid beef fat would be responsible for the mouth-coating, juiciness perception of the material. Furthermore, the appearance of the adipose tissue changed with temperature. The 20° C. sample appeared to be less translucent than at 55° C. This is again related to the phasic behavior of the lipids within the adipose tissue. The solid lipids are less able to transmit light in comparison to the liquid lipids, changing the visual properties of the adipose tissue.

### Conclusion and Recommendations

The results of the benchmarking test revealed insights into the structure of beef adipose tissue and provided practical targets for the development of the material. Firstly, the mechanical properties of the adipose tissue may be dependent on both the extra cellular matrix and the type of fat present within inside. Secondly, the mechanical properties seem to be dependent on the temperature at which they are measured at. Finally, the visual properties of the adipose tissue also seem to be dependent on the temperature. From a practical point of view, benchmarking of the developed materials will be based on the cooked beef adipose tissue.

2. Polymers for the structuring of Oleogels

### Materials and Methods

1.2 wt % solution of agar-agar, 2.4 wt % low acyl gellan gum and 2.4 wt % high acyl gellan gum were prepared by dissolving each hydrocolloid in deionized water at 95° C. An 0.3 wt % xanthan gum solution was created by shearing the polymer into room temperature deionized water using an ultraturrax. All the aforementioned polymer solutions were then held at 95° C. till ready for the oleogel protocol.

A 2.4 wt % HPMC (Hydroxypropyl methyl cellulose) solution was prepared by shearing into cold (5° C.) water using an ultraturrax. Emulsions were prepared by shearing the sunflower oil into the HPMC solution by means of an ultraturrax. Oleogels were then prepared by dispersing the required, hot (95° C.) polymer solution into the HPMC-sunflower oil emulsion using a hand blender. For the low and high acyl gellan gum oleogels, 10 g of 1 wt % CaCl₂ solution was added before the solution reached 60° C. All four oleogels were then dried at 80° C. for 32 hours. Dehydrated samples were analyzed for their cooking performance. Briefly, a non-stick pan was placed onto an induction burner set to medium heat (setting 5). The samples were cooked for 3 minutes, then removed from the pan.

TABLE 1
Xanthan gum based oleogel recipe.

| Ingredient | Quantity (g) | % |
|---|---|---|
| Sunflower oil | 150 | 50 |
| 0.3 wt % Xanthan gum sol. | 75 | 25 |
| 2.4 wt % HPMC sol. | 75 | 25 |

TABLE 2
Agar based oleogel recipe.

| Ingredient | Quantity (g) | % |
|---|---|---|
| Sunflower oil | 150 | 50 |
| 1.2 wt % Agar gum sol. | 75 | 25 |
| 2.4 wt % HPMC sol. | 75 | 25 |

TABLE 3
Low Acyl gellan gum based oleogel recipe.

| Ingredient | Quantity (g) | % |
|---|---|---|
| Sunflower oil | 150 | 48.4 |
| 2.4 wt % Low acyl gellan gum sol. | 75 | 24.2 |
| 2.4 wt % HPMC sol. | 75 | 24.2 |
| 1 wt % CaCl₂ sol. | 10 | 3.2 |

TABLE 4
High acyl gellan gum based oleogel recipe.

| Ingredient | Quantity (g) | % |
|---|---|---|
| Sunflower oil | 150 | 48.4 |
| 2.4 wt % High acyl gellan gum sol. | 75 | 24.2 |
| 2.4 wt % HPMC sol. | 75 | 24.2 |
| 1 wt % CaCl₂ sol. | 10 | 3.2 |

### Results

Results of the creation of the four oleogels are shown in Table 5. Agar-agar failed to form a gel and clear separation could be seen between the lipid and aqueous phases. Xanthan, low and high acyl gellan gums were all able to form oleogels. However, the low and high acyl gellan gums appeared to form oleogels that were self-supporting immediately after gelation. The xanthan oleogel was on the other hand not self-supporting and only achieved a structure after the dehydration was completed. A large amount of oil appeared to be released from the xanthan gum oleogel. Low and high acyl gellan gums had a higher propensity to hold onto the oil fraction and showed little oil drainage.

TABLE 5
visual characteristics of the oleogels before and after pan searing.

| Polysaccharide | Pre Cooking | Post Cooking |
|---|---|---|
| 0.3 wt % Xanthan | Foamy, light structure formed. | Browning where in contact with the |
| gum | Large quantity of oil released | pan. Lightly crispy structure formed. |
| | by the oleogel during dehydration. | |
| | Structure is slightly elastic but | |
| | fractures easily. | |
| 1.2 wt % Agar | Phase separation occurred on | N/A |
| | gel cooling resulting in no | |
| | oleogel formation. | |
| 2.4 wt % Low acyl | A brittle, white, opaque gel was | Little surface browning, some |
| gellan gum | formed. Some elasticity when | dehydration of the contact surface. |
| | compressed lightly. | Little change to the overall structure |
| | | of the oleogel. |
| 2.4 wt % High acyl | A white, rubbery, elastic gel | Large amount of browning occurred |
| gellan gum | was formed. | on the surface in contact with the pan. |
| | | No crispy surface was formed, rather |
| | | a rubbery texture occurred. |

### Discussion

The presence of different aqueous phase polymers appeared to have a large impact on the material properties of the oleogels. This was shown by the large variation in the textures formed between the xanthan gum, low and high acyl gellan gum oleogels. Interestingly, the low and high acyl gellan gums showed strikingly different material properties. The low acyl gellan gum seemed to form brittle structures Whereas high acyl gellan gum may result in a material with more elastic-like properties. Interestingly, it is possible to blend these two hydrocolloids to form gels which blend these two material properties. Xanthan gum on the other hand does not form a network. Rather, it stabilizes the oleogel by viscosifying the aqueous phase, which reduces coalescence and water drainage. This property of xanthan gum does not appear to be significantly better than that of gellan gum. This was seen by the large amount of oil drainage found after drying of the gel.

### Conclusion and Recommendations

The formation of oleogels with different properties using gellan gum in its high and low acyl state might be interesting. Xanthan gum was shown to be fairly effective in forming a stable oleogel, however it required several hours of drying before a self-supporting structure was formed.

### 3. Effect of the Lipid Phase on the Mechanical Properties of Gellan Structured Oleogels

Animal fats are comprised of mixtures of triacylglycerols (TAGs), whose relative proportions determine their physiochemical properties. Fats that are solid at room temperature are composed of high melting point TAGs whose crystals form a network that contain those of a lower melting point.

Since oleogels are especially emulsions with a structural network, the physiochemical properties and behavior of the fats in the system may alter the oleogel's structure.

### Materials and Methods

The mechanical properties of the oleogels prepared were analyzed using the TPA protocol given below. Photographs of the samples were taken after storage of the gels at 5° C. for 12 hours. Texture Profile Analysis (TPA) was used to determine the mechanical properties of the oleogels. Samples, taken in duplicate, were taken from each gel. The gel samples were cut into cylinders of 20 mm height and 15 mm diameter using a ring-mold cutter. Uniaxial compression was performed at a speed of lmms⁻¹ to a target strain of 0.5 and a trigger load of 0.05N. Unless otherwise stated, when TPA is mentioned, it refers to this protocol.

### Commercially Available Fats

Oleogels were prepared with 6 commercially available fats. These were CLSP, coconut oil, cocoa butter, Pristine, Revel ST50 and sunflower oil. To prepare the oleogels, a 2.4 wt % HPMC solution was prepared with cold (5° C.) deionized water. 2.4 wt % Low and high acyl gellan gum gels were prepared by dispersing each polymer in hot (95° C.) water, followed by holding in a water bath (95° C.) for the duration of the experiment. To create the emulsions, the fats were warmed to 95° C. then homogenized with the HPMC solution to form an emulsion. Following emulsion formation, the low and high acyl gellan gum gels were added. 2 ml of a 1 wt % CaCl₂ solution was added while the temperature of the polymer dispersion was >60° C. The dispersions were then poured into molds and stored at 5° C. for 12 hours before being analyzed.

TABLE 6
Recipe used for the formation of the oleogels with commercially
available fats. Fat variations can be found in Table 7.

| Ingredient (g) | Mass (g) | |
|---|---|---|
| Fat variation | 50 | 49% |
| 2.4 wt % HPMC | 25 | 25% |
| 2.4 wt % LAGG | 12.5 | 12% |
| 2.4 wt % HAGG | 12.5 | 12% |
| 1 wt % CaCl₂ | 2 | 2% |

TABLE 7
Commercially available fats. SFCs were based on manufacturer
data sheets or peer review publications.

| Fat | SFC % at 20° C. | Supplier |
|---|---|---|
| CLSP | 77 | Bunge Loders Kroklaan |
| Coconut oil | 36 | Local supermarket |
| Cocoa butter | 67 | Local supermarket |
| Prestine | 71.5 | Bunge Loders Kroklaan |
| Revel ST50 | 73 | Bunge Loders Kroklaan |
| Sunflower oil | 0 | Local supermarket |

### Solid Fat Content (SFC)

Oleogels were prepared with varying proportions of solid fat. Solid fat was added in the form of Revel ST50 to sunflower oil. Both the fats were heated to 95° C. then, the required proportions (Table 9) were homogenized together using an ultraturrax. The fat was then homogenized into the HPMC solution and the oleogel procedure as described in experiment 1. SFC % was calculated based on the amount of solid fat present in the Revel ST 50 manufacturers notes.

TABLE 8
Aqueous phase of the oleogels used for the determination of
SFC. The proportions of fat used can be found in table 4.

| Ingredient (g) | Mass (g) | |
|---|---|---|
| 2.4 wt % HPMC | 25 | 25% |
| 2.4 wt % LAGG | 12.5 | 12% |
| 2.4 wt % HAGG | 12.5 | 12% |
| 1 wt % CaCl₂ | 2 | 2% |

TABLE 9
Proportions of fat used for the determination of SFC
on the mechanical properties of the oleogels. SFC
% was calculated from the manufacturer data sheets
provided by Bunge Loders Croklaan for Revel ST 50.

| | 1:4 | 2:3 | 3:2 | 4:1 |
|---|---|---|---|---|
| Sunflower oil (g) | 40 | 30 | 20 | 10 |
| Revel ST 50 (g) | 10 | 20 | 30 | 40 |
| SFC % at 20° C. | 7.3 | 14.6 | 21.9 | 29.2 |

### Results

### Commercially Available Fats

TABLE 10
Young's moduli (±standard deviation, n = 2) of the
oleogels derived from first compression during TPA.

| | |
|---|---|
| 0 hr | 24 hr |

| | | | | |
|---|---|---|---|---|
| CLSP | 0.079 | (0.045) | 7.21 | (1.34) |
| Revel ST 50 | 0.2 | (0.12) | 3.55 | (2.82) |
| Prestine | 0.25 | (0.3) | 2.431 | (0) |
| Cocoa butter | 19.22 | (0.04) | 39.69 | (0.65) |
| Coconut oil | 3.14 | (0.02) | 5.88 | (1.52) |
| Sunflower oil | 5.01 | (0) | 4.64 | (0.67) |

The results of the TPA test showed that hardness of the gels immediately after dehydration varied between 0.21 and 4.64N and increased dramatically with 24 hours of dehydration. Moduli of the oleogels, which correspond to their stiffness, all showed an increase except for sunflower oil which showed a decrease (Table 10). Cohesiveness appeared to be less affected by drying, with little difference in the samples being seen over time.

All the types of commercially available fat used were able to be formed into oleogels. A sample with Biscutine F was prepared but the resulting oleogel was damaged during the demolding process and as a result could not be assessed by TPA. In general, all the oleogels were white in color and matt in appearance. The cocoa butter oleogel had a light yellow tinge to it, which mimicked the color seen by beef fat. The sunflower oil oleogel had a glossy appearance and an oily texture in comparison with the other oleogels.

### Solid Fat Content (SFC)

Results of the SFC % on the mechanical properties of the oleogels show that hardness increased linearly for increasing amount of SFC % in the oleogel. The modulus of the gel also appeared to increase linearly after 14.6% SFC was present in the oleogel system while cohesiveness did not appear to be affected by the SFC %.

### Discussion

The SFC % experiments suggest that controlled addition of solid fat to a liquid fat in an oleogel system may alter the hardness and modulus of that gel. Interestingly, if the hardness of 100% Revel ST50 (SFC %=36.5) were to be plotted, it would not fit linear behavior, suggesting that the effect of the hard fat on the hardness forms an asymptote at approximately 5N of hardness. Modulus, which corresponds to stiffness, seems to follow a similar trend with 100% revel ST 50 (36.5% SFC) showing a modulus of 0.20 Pa while that of 29 SFC % 0.22 Pa. Overall, this suggests that the hardness and stiffness of the oleogel structure may be dependent on the type of fat that is emulsified within. Moreover, the SFC % appears to play a role in determining the gel hardness. Comparing the extremes of SFC % given in Table 7, it can be seen that those fats with low SFC % (sunflower oil and coconut oil) showed lower hardness than those with higher SFC % (cocoa butter and revel ST 50). However, these did not correlate well with the SFC % when the other fats were included. This may be due to the effect of temperature on the melting point of the fats. Though the experiment tried to maintain the temperature of the gels at 20° C., it was not possible to measure the internal temperature of the samples as that would cause flaws in the material, resulting in atypical fracture leading to results that are not indicative of the overall structure. Drying appeared to increase the hardness and modulus of the gel. Since water droplets do not participate in a fat crystal network, they would act as inactive fillers, reducing the strength of the network. Drying of the oleogel would reduce the number and size of these water droplets, increasing the strength of the fat crystal network.

### Conclusion and Recommendations

The results of these experiments show that the hardness of the fat may also be tuned by the addition of solid fat to the system. This may be the result of the formation of a particulate fat crystal network within the oleogel system which is related to the SFC of the fat mixture.

### 4. Effect of Low and High Acyl Gellan Gum on the Mechanical Properties of Oleogels

Gellan gum is formed of a tetrasaccharide repeating unit of 2 β-d-glucose, 1 β-d-gluconorate and 1 α-L-rhamnose. The native polysaccharide, as synthesized by the bacteria Sphingomonas Elodea, has acyl substituents on the first glucose unit. These may be removed by processing to form low acyl gellan gum. Gellan gum creates a gel network by conversion of the polymer from a disordered coil to a stable double-helix that aggregates in the presence of salts or reduced pH. The acyl substituents sterically hinder the formation of aggregates, causing a change in the created network.

Changes to the molecular aggregation of the polysaccharide depend on the degree of acylation of the polymer which result in changes to the macroscopic deformation of the gels that are produced. For example, pure Low acyl gellan gels form non-elastic, brittle gels while pure high acyl gellan gels tend to be soft and ductile in nature. Blending of the low and high acyl gellan polymers give gels with mixtures of their mechanical properties. Experiment 0 showed that high and low acyl gellan gums are able to form gel networks in a multiphase system that appeared, by sensory analysis, to be similar to their behavior in single phase systems. It may then be possible to tune the mechanical properties of the oleogel based on the proportion of high to low acyl gellan gum present within the system. Thus, the aim of this experiment is to alter the ratio of low:high acyl gellan gum (LAGG:HAGG) and study the effects by means of the mechanical properties of the resulting oleogels. The outcome of this experiment will determine what LAGG:HAGG ratio will be used for subsequent experimentation.

### Materials and Methods

A 2.4 wt % HPMC solution was prepared by dissolving the polymer into cold (5° C.) deionized water using an ultraturrax. Deionized water was heated to 95° C. and blended with the 2.4 wt % LAGG and 2.4 wt % HAGG. The L/HAGG solutions were kept in a water bath set to 95° C. over the course of the experiment. To create each gel, 50 g of sunflower oil was emulsified into 25 g of 2.4 wt % HPMC solution. This was then warmed to 60° C. before being homogenized with the required amount of LAGG or HAGG (Table 11). 2 g of 1 wt % CaCl₂) was then added to the mixture before being poured into cylindrical molds. Gels were dehydrated at 70° C. for a total of 24 hours. Samples were taken at 0 hours for TPA. At 0 and 24 hours photography and thermal stability were assessed.

TABLE 11
The proportions of LAGG and HAGG used to form the oleogels.

| | LAGG:HAGG Ratio | | | | |
|---|---|---|---|---|---|
| Ingredient (g) | 1:0 | 1:1 | 1:3 | 3:1 | 0:1 |
| Sunflower oil | 50 | 50 | 50 | 50 | 50 |
| 2.4 wt % HPMC | 25 | 25 | 25 | 25 | 25 |
| 2.4 wt % LAGG | 25 | 12.5 | 6 | 19 | 0 |
| 2.4 wt % HAGG | 0 | 12.5 | 19 | 6 | 25 |
| 1 wt % CaCl₂ | 2 | 2 | 2 | 2 | 2 |

Thermal stability of the gels was tested by placing the gel cylinder into a pan and cooking on medium high heat for 3 minutes.

### Results

Variation of the ratio of LAGG to HAGG altered the mechanical properties of their respective oleogels. Though it was possible to form gels from all the variations of LAGG to HAGG, 1:3 displayed some phase separation, thus not forming a homogenous gel, and so its results were not included in the analysis.

The ratio of LAGG:HAGG appeared to linearly correlate to the hardness (R=0.959) and cohesiveness (R=0.981). Springiness appeared to increase linearly past a 1:1 ratio while modulus only increased once no HAGG was present in the oleogel system. Drying of the samples increased the sensory hardness of the gels but also appeared to increase their overall perceived gumminess. In general, browning of the samples occurred and increased after 24 hours of drying. All samples were thermally stable with no loss of structure after several minutes in a pan set to medium high heat.

TABLE 12
Visual and sensory properties of the oleogels after dehydration and cooking.

| | 0 hr | 0 hr | 24 hr | 24 hr |
|---|---|---|---|---|
| LAGG:HAGG | (pre-cooking) | (post-cooking) | (pre-cooking) | (post cooking) |
| 1:0 | Hard, brittle | Little surface | Hard, brittle gel. | Good surface |
| | gel | browning but | Increased | browning while |
| | | retains structure | gumminess. | maintaining surface |
| | | well. | | structure. |
| 3:1 | Relatively hard | Good surface | Sample hardness | Sample appears to |
| | gel with some | browning, | increased. | puff up slightly. |
| | elasticity. | maintains | Gumminess appears | Light surface |
| | | structure well. | to take over too. | browning. |
| 1:1 | Elastic gel with | Good surface | Sample hardness has | Very deep surface |
| | good hardness | browning, | increased while the | browning with |
| | when | maintains | gel appears to | structure maintained |
| | compressed | structure well. | become gummier. | after cooking. |

### Discussion

The results of this experiment suggest that the mechanical properties of the oleogel were influenced by the LAGG:HAGG ratio. A larger proportion of HAGG would improve the stability of the gel network due to the larger amount of glycerate groups. This would point towards choosing a ratio of LAGG:HAGG that is not too high in order to benefit from the stabilizing effect of the glycerate groups. However, the increased hardness as a result of the higher LAGG:HAGG may be considered too when comparing their mechanical properties to that of the beef adipose tissue benchmark.

All the gels maintained a high level of structure throughout the searing process (Table 12). This may be a result of the high thermal hysteresis of gellan gum gels, with the pan surface not reaching temperatures high enough to disorder and melt the gel network. All the gels showed surface browning too. Since no proteins were present in the system, the cause of this surface browning may have been pyrolization of the HPMC, LAGG and HAGG. This would not appear to be valuable from a sensory point of view as the extra cellular matrix of beef adipose tissue is mostly composed of proteins. These would brown mainly as a result of the maillard reaction, imparting different color compounds and a variety of flavors. In further tests, this is a point that may be considered.

A large standard deviation was seen in the measured hardness of the gels. This may be related to deformities such as air bubbles within the gel system which weaken the gel, giving points for mechanical failure to take place. This may be taken into account when preparing the oleogels for TPA in subsequent experimentation. Gels with a LAGG:HAGG ratio of 1:3 fractured after the first compression. This may have affected the springiness measurement from the TPA as the gels tended to flow and not provide resistance to deformation, preventing an accurate measurement from taking place. This could be altered in the next set of experiments by reducing the strain on the gels from 0.5 to 0.25.

### Conclusion and Recommendations

This series of experiments has indicated that the LAGG:HAGG ratio may affect the mechanical properties of the oleogel system. A 1:1 ratio seems to strike a good balance between hardness and cohesiveness while the modulus appears to stay relatively low, giving it a good elasticity. This would also prevent the gels from fracturing after being deformed significantly. A point to note is that the gel hardness at 20° C. was not close to that of the adipose tissue benchmark. This may be related to the physical properties of the mixture of TAGs found in beef adipose tissue which, tend to be solid at room temperature. This may have a remarkable impact on the physical properties of the oleogel, considering that the fat phase takes up roughly 50% of the total gel.

5. Replacement of HPMC with Transglutaminase Crosslinked Soy Protein Isolate

The addition of proteins to the structure could also help in improve flavor and color formation during browning by providing reactants for the maillard reaction to take place. Vegetable proteins may also be used as emulsification agents.

Microbially derived transglutaminase (mTgase) catalyzes an acyl transfer between glutamyl residues introducing intermolecular covalent cross-links. Currently, the oleogels lack elasticity due to the brittle nature of the gel formed by the gellan gum network. Since the transglutaminase induced network formation forms strong covalent bonds that are able to withstand deformation and store energy elastically, it may be beneficial to the formulation to include this network within the oleogel.

### Materials and Methods

An 8 wt % SPI solution was prepared by dissolving the SPI in deionized water by stirring overnight at room temperature on a magnetic stir plate. A 1.2 wt % solution of HPMC was prepared by dissolving in cold (5° C.) water using a homogenizer. 2.4 wt % solutions of low and high acyl gellan gum were produced by dissolving into hot (95° C.) water and shearing using an ultraturrax. Samples were subjected to photography, thermal stability testing and TPA.

Replacement of HPMC with SPI

To form the gels, the SPI and HPMC solutions were mixed in the proportions shown in Table 13. The resulting polymer mixture was then heated to 60° C. and the Revel ST 50 was emulsified into the polymer mixture. Following this, the low and high acyl gellan gums were added to the polymer mixture. The CaCl₂) was then added and the gel cooled to 5° C.

TABLE 13
Proportions of HPMC and SPI used to structure
the interface of the oleogel.

| Ingredient (g) | Mass (g) | | | | |
|---|---|---|---|---|---|
| 8 wt % Soy protein isolate | 25 | 0 | 12.5 | 7 | 18 |
| 2.4 wt % Low acyl gellan gum | 12.5 | 12.5 | 12.5 | 12.5 | 12.5 |
| 2.4 wt % High acyl gellan gum | 12.5 | 12.5 | 12.5 | 12.5 | 12.5 |
| 1.2 wt % HPMC | 0 | 25 | 12.5 | 18 | 7 |
| 1 wt % CaCl₂ Sol. | 2 | 2 | 2 | 2 | 2 |
| Revel ST 50 | 50 | 50 | 50 | 50 | 50 |

Formation of an mTgase Induced Protein Gel Network within an Emulsion Filled Gellan Gum Matrix

TABLE 14
Recipes used to test whether mTgase could alter the mechanical and
culinary properties of the soy protein isolate stabilized oleogels.

| Ingredient (g) | (+) mTgase | (−) mTgase |
|---|---|---|
| 8 wt % Soy protein isolate | 25 | 25 |
| 2.4 wt % Low acyl gellan gum | 12.5 | 12.5 |
| 2.4 wt % High acyl gellan gum | 12.5 | 12.5 |
| 1 wt % CaCl₂ Sol. | 2 | 2 |
| Activa RM | 0.8 | — |
| Revel ST 50 | 50 | 50 |

The Revel ST 50 was emulsified into the 8 wt % soy protein isolate solution. Following this, the low and high acyl gellan gum solutions were added to the polymer dispersion. The CaCl₂ solution was then added and the temperature of the dispersion reduced to 55-60° C. At this point, the Activa RM was stirred into the mixture by means of a spatula. The dispersion was then homogenized using an ultraturrax and poured into molds. The molded oleogels were then stored at 5° C. for 1 hour to set the gellan gum network after which they were transferred to a dehydrator and incubated at 37° C. for 3 hours. Samples were then dried at 37° C. for a further 4 hours.

### Results

Replacement of HPMC with SPI

Gels containing mixtures of HPMC and SPI were unable to form. Rather, phase separation took place on immediate mixing of the two polymers. Thus, emulsion formation with these incompatible polymers was not possible. Only 100% SPI or 100% HPMC emulsions were able to be formed.

Results of the TPA test on the (+) and (−) mTgase trials before and after drying showed an increase in hardness and cohesiveness after mTgase addition. Little change was seen in the standard deviation of the samples after mTgase addition. Comparing samples before and after drying, all samples showed an increase in hardness as well as young's modulus. A decrease in the cohesiveness of the samples was seen after the drying protocol was completed. A large difference can be seen between the cohesiveness of the (+) and (−) mTgase samples after drying.

TABLE 15
Sensory and visual properties of the
dehydrated oleogels after pan frying.

| | Before | |
|---|---|---|
| Sample | Cooking | After Cooking |
| + mTgase | Hard gel that | Forms a thin film of crispy yellow protein. |
| | deforms when | No retention of overall structure what so |
| | pressed. | ever. |
| − mTgase | Hard gel that | Structure highly maintained throughout the |
| | deforms when | searing process. A soft, elastic gel is left |
| | pressed. | with a thin crispy surface where the gel |
| | | was in contact with the pan. |

The dried samples were assessed for their thermal stability. A striking difference in the retention of structure can be seen between the (+) mTgase and (−) mTgase samples. No mTgase addition resulted in the formation of a thin, crisp protein wafer while the addition of mTgase allowed the oleogel to retain its structure entirely.

### Discussion

The addition of mTgase appeared to alter the thermal stability of the oleogels. The sample without mTgase showed a complete collapse of structure in comparison to the sample with mTgase that maintained its composition throughout the searing process. It may also be possible to see this in the change in hardness and cohesiveness. mTgase forms covalent ε-(γ-Glu)Lys bonds between proteins which have been shown to be quite heat tolerant in comparison to weaker interactions. It is interesting to note that gellan gum shows melting point hysteresis after gel setting. This thermal hysteresis did not however seem to be in effect within the sample without mTgase. This could suggest that the protein network appears to alter the structure that the gellan gum gel can make, which is less thermally stable. However, the hardness of the gels formed were an order of magnitude lower than that of the pork back-fat. It may then be possible to increase the hardness of the oleogel by tuning its composition for stronger gellan gum network interactions.

When HPMC and soy protein isolate were mixed, phase separation was observed. At pH 7, both SPI and gellan gum would be highly negatively charged. Considering their high concentrations and like-charges, it is possible that the phase separation was a result of depletion interactions between the two polymers. It may also be likely that, since both polymers are surface active, there would be competition for the interface.

### Conclusion & Recommendations

It could then be concluded that the covalent cross-linking of the SPI by mTgase may have caused the formation of a heat-tolerant protein network within the gellan gum network. This suggests that it may be possible to form oleogels that have elastic properties of mTgase induced SPI gels, along with the hardness associated with gellan gum gels. The lack of thermal stability seen within the samples without mTgase suggest that the thermal hysteresis of gellan gum may not contribute significantly to the stability of the whole gel. It may be worthwhile investigating how altering the quantity of gellan gum in the system affects the thermal stability of the oleogel.

### 6. Effect of the Gellan Gum Matrix on the Mechanical and Thermal Properties of the Oleogel

The previous experiment suggested that microbial transglutaminase could crosslink soy proteins within an ionically linked gellan gum network. The results also indicated that the thermal stability of the gel was not dependent on the gellan network (Experiment 0), as the sample that contained no transglutaminase did not hold its structure. The aim of this experiment is to see if the gellan gum network is necessary for the formation of a thermally stable gel.

### Materials and Methods

Sets of 0.24 wt %, 1.2 wt % and 2.4 wt % low and high acyl gellan gum (LAGG and HAGG respectively) were prepared by mixing with hot (95° C.) deionized water using an ultraturrax. An 8 wt % soy protein isolate (SPI) solution was prepared by mixing into room temperature deionized water with an ultraturrax. Gels were formed by emulsifying hot (95° C.) Revel ST into the SPI solution that was warmed to 60° C. in a water bath. The required (Table 16) LAGG/HAGG solutions were then blended into the emulsion and mixed with 1 wt % CaCl₂. The temperature was then measured till between 55-60° C. and mTgase powder was then mixed into the polymer dispersion using the ultraturrax.

The gels were then cooled to 5° C. for 1 hour, incubated at 37° C. for 3 hours and then dehydrated at 37° C. for 3 hours. Prior to dehydration, samples were collected for uniaxial compression testing.

TABLE 16
Varying proportions of LAGG/HAGG solutions
used to structure the oleogel.

% LAGG/HAGG

| Ingredient | 0% | 0.24% | 1.2% | 2.4% |
|---|---|---|---|---|
| Revel ST50 (g) | 50 | 50 | 50 | 50 |
| Activa RM (g) | 0.4 | 0.4 | 0.4 | 0.4 |
| 1 wt % CaCl₂(g) | 2 | 2 | 2 | 2 |
| 0.24 wt % LAGG (g) | 0 | 12.5 | 0 | 0 |
| 0.24 wt % HAGG (g) | 0 | 12.5 | 0 | 0 |
| 1.2 wt % LAGG (g) | 0 | 0 | 12.5 | 0 |
| 1.2 wt % HAGG (g) | 0 | 0 | 12.5 | 0 |
| 2.4 wt % LAGG (g) | 0 | 0 | 0 | 12.5 |
| 2.4 wt % HAGG (g) | 0 | 0 | 0 | 12.5 |

### Results

The mechanical properties of the oleogels varied with the amount of LAGG/HAGG present in the system. 0% LAGG/HAGG could not be measured by texture analysis due to its soft structure. The hardness of the oleogels increased with increasing amount of gellan gum, with minimum values of 1.5(±0.1)N for 0.24 wt % LAGG/HAGG to 9.6(±0.08)N for 2.4 LAGG/HAGG. Modulus also appeared to increase from 0.08(±0.01) to 0.43(±0.16) for 0.24 to 2.4 wt % LAGG/HAGG respectively. Cohesiveness did not appear to be affected by changing the amount of LAGG/HAGG.

The results of the thermal stability of the oleogel are presented in Table 17 and images were taken. The images suggest that the LAGG/HAGG may have an impact on how stable the oleogel is to high temperature. Although not evident in the pictures, the 1.2 wt % LAGG/HAGG sample did show some structure maintained. Albeit a small amount in comparison to the 2.4 wt % samples.

TABLE 17
Visual observations of the different oleogels
made during the pan frying session.

| % LAGG/HAGG | Post cooking |
|---|---|
| 0% | Sample structure is completely lost after 2 minutes |
| | in the pan. Acts more like butter than an oleogel. |
| 0.24% | Similar to 0%, the sample structure disappears |
| | during cooking. |
| 1.2% | Sample withstands heat for much longer than |
| | 0.24 wt % but the majority of the sample is |
| | lost after the cooking period. |
| 2.4% | Structure is maintained during cooking. |

### Discussion

The results show that the gellan matrix within the oleogel may be necessary for its thermal stability. This suggests that the resistance to the oleogel melting may come as a result of the combined properties of the gellan gum and cross-linked soy protein isolate networks. Considering that the SPI and gellan gum are above their pI and pKa respectively, they would both be negatively charged. Due to this, their interactions would be repulsive, preventing the formation of any complexes between the two polymers. The presence of mTgase would crosslink the proteins between the emulsion droplets. As a result, the emulsion droplets would become active fillers in the SPI gel network. However, the removal of one of the networks removes the thermal stability of the oleogel. This suggests that each gel network is dependent on the crosslinking of the other gel network for the oleogel to have thermal stability.

### Conclusion and Recommendations

The results of this experiment show that the oleogel formulation benefits from the presence of gellan gum in a range of 0.3-0.6 wt % for thermal stability of the gel. The results also show that the hardness and modulus of the gel may be dependent on the amount of gellan gum present in the system. This supports the initial hypothesis that a high internal phase emulsion system could be hardened by including gellan gum in the formulation. The results also point towards a gel system whose constituents destabilize each other when their respective crosslinkers are not included.

### 7. The Effect of Covalent and Ionic Crosslinking on the Mechanical Properties of Gellan Gum and Soy Protein Isolate Gel

Previous experimentation showed differences in the mechanical properties of oleogels that used a principle of ionic-covalent sequential gelling. However, the results did not show any drastic changes to the gels mechanical properties. This is hypothesized to be due to the presence of a fat that is solid at room temperature in quantities that are a significant proportion of the oleogel formulation. Thus, the aim of this experiment is to demonstrate what the mechanical properties of the oleogel aqueous matrix are like when a solid fat is not present in the system.

### Materials and Methods

8 wt % soy protein isolate was dispersed into room temperature deionized water and mixed using an ultraturrax. 1.5 wt % low acyl and high acyl gellan gum solutions were created by blending the polymers into hot (95° C.) deionized water. The SPI, LAGG and HAGG solutions were then placed into a hot water bath set at 95° C. The polymer solutions were then combined together as described in Table 18. An 0.25M CaCl₂ was then added according to Table 18. The temperature of the gel was measured and when between 55-60° C., the mTgase was added, according to Table 18. The samples were then homogenized using the ultraturrax, poured into molds and kept at 5° C. for 1 hour. Following this, the samples were incubated at 40° C. for 1 hour. The gels were then cooled to 5° C. for analysis the following day.

Samples were cut into cylinders of 15 mm height and 20 mm diameter. A single uniaxial compression test was performed to ascertain the fracture stress, fracture strain and young's modulus of the gels. The texture analyzer used a cylindrical probe, compressing at v=1 mms⁻¹ to a target strain of 0.5. The fracture stress and fracture strain was assumed to be the maximum force and displacement achieved after compression. Youngs modulus was calculated to be the slope of the stress-strain curve during from 0.15-0.2 strain.

TABLE 18
Relative proportions of each recipe used to demonstrate
the effects of each crosslinking agent.

| | [M−][C−] | [M+][C−] | [M−][C+] | [M+][C+] |
|---|---|---|---|---|
| 1.5 wt % LAGG(g) | 12.5 | 12.5 | 12.5 | 12.5 |
| 1.5 wt % HAGG (g) | 12.5 | 12.5 | 12.5 | 12.5 |
| 8 wt % SPI (g) | 25 | 25 | 25 | 25 |
| [M] mTgase (g) | 0 (−) | 0.4 (+) | 0 (−) | 0.4 (+) |
| [C] 0.25M CaCl₂ Sol.(g) | 0 (−) | 0 (−) | 1 (+) | 1 (+) |
| DI water | 1 | 1 | 0 | 0 |

### Results

TABLE 19
Results from the uniaxial compression test. Values are shown
as means with standard deviations (n = 2) in brackets.

| | [M−][C−] | [M+][C−] | [M−][C+] | | [M+][C+] | |
|---|---|---|---|---|---|---|
| Fracture stress (Pa) | 1.74 (0.12) | 5.03 (0.51) | 5.40 | (0.40) * | 2.97 | (0.08) * |
| Fracture strain | 0.49 (0.00) | 0.50 (0.00) | 0.38 | (0.01) * | 0.30 | (0.01) * |
| Modulus (Pa) | 1.67 (0.01) | 2.13 (0.03) | 6.63 | (0.81) | 5.56 | (1.10) |

Results of the single uniaxial compression tests are presented in Table 19. A variety of mechanical responses were recorded depending on whether or not the ionic or covalent crosslinking agents were added to the formulation. Gels which were ionically crosslinked fractured while those without displayed elastic behaviors to 50% compression with no fracture. The addition of ionic crosslinkers also drastically increased the modulus of the gels (Table 19). Fracture stress was increased on addition of either the covalent or ionic crosslinker, but the addition of both reduced the fracture stress. This was not reduced to the values seen when no crosslinking agent was added.

### Discussion

This experiment seems to demonstrate the effect of mTgase on the mechanical properties of the gels. Comparing [M+][C−] to [M−][C−] we can see that, though both had elastic behaviors, the addition of mTgase resulted in a much high resistance to deformation. This may be related to the ability of covalent soy protein bonds to store energy more effectively than bonds formed from hydrophobic interactions, which are weak and easily disrupted. This may also be indicative of the heat tolerance behavior shown in previous experiments but cannot be verified without further analysis of this relationship.

### Conclusion

The aim of this experiment was to look at how the matrix of the oleogel is affected by the presence of the covalent and ionic crosslinkers. The results showed that the ionic and covalent crosslinking agents created gels with a range of mechanical properties. What can be confirmed from this experiment is that covalent crosslinker may increase the elasticity of the gel while the ionic crosslinker may increase the gel to fracture.

### 8. Effect of CaCl₂ Concentration on the Mechanical Properties and Heat Stability of Crosslinked Emulsion Oleogels

The aim of this experiment is to examine the effect of the CaCl₂ concentration on the mechanical properties structural characteristics of the oleogels via the changes in its mechanical properties.

### Materials and Methods

An 8 wt % soy protein isolate solution was emulsified with sunflower oil. The resulting emulsion was heated in a water bath to t>40° C. 2.4 wt % low and high acyl gellan gum solutions, held at 95° C., were weighed and added to the emulsion. The mixture of emulsion and gellan gum was homogenized for 1 minute. The required amount of CaCl₂ was added using a pipette (Table 21), followed by a further 1 minute homogenization step. The temperature of the gel was measured and when it was <60° C., 1 ml of 10 wt % transglutaminase was added. The mixture was then homogenized for 1 minute before being placed into molds and refrigerated for 2 hours. After this, the samples were placed in an incubator (t=40° C.) for 2 hours. At this point, a sample was taken from the gels. The rest of the gel was placed into dehydrated at 40° C. for a further 2 hours to be dehydrated for culinary performance testing.

Undehydrated and dehydrated samples were subjected to TPA to ascertain the mechanical properties of the gel. Images were taken of both the dehydrated and undehydrated samples too as well as descriptions of the visual texture. Dehydrated samples were analyzed for their cooking performance. Briefly, a non-stick pan was placed onto an induction burner set to medium heat (setting 5). The samples were cooked for 3 minutes, then removed from the pan.

The samples were then subjected to TPA and cooked on high heat for 3 minutes.

TABLE 20
Recipe used for the formation of the gels. X
mM represents the varying amount of CaCl₂, the
amounts of which are described in Table 21.

| | | |
|---|---|---|
| Ingredient | Quantity | % |

| | | | |
|---|---|---|---|
| Sunflower oil | 50 | g | 49.01 |
| 8 wt % Soy protein isolate sol. | 25 | g | 24.50 |
| 2.4 wt % Low acyl gellan gum sol. | 12.5 | g | 12.25 |
| 2.4 wt % High acyl gellan gum sol. | 12.5 | g | 12.25 |
| 10 wt % Transglutaminase sol. | 1 | ml | 0.98 |
| X mM CaCl₂ | 1 | ml | 0.98 |

TABLE 21
X mM CaCl₂ in solution and their calculated concentrations
relative to the entire gel recipe.

| Solution Concentration (X mM) | Final Gel Conc. (mM) |
|---|---|
| 250 | 4.90 |
| 500 | 9.80 |
| 750 | 14.71 |
| 1000 | 19.60 |

### Results

Though the addition of varying amounts of CaCl₂ resulted in gel formation at every concentration tested, each concentration yielded a different texture. Visual differences were noticed between samples and are summarized in Table 24. Oleogels made with concentrations of CaCl₂>9.8 mM maintained their structure during the process of pan searing. All samples formed a crispy, lightly browned protein film on the face of the gel in contact with the pan. Hardness and modulus showed similar trends, with maxima forming at a CaCl₂ concentration of 9.8 mM followed by a sharp decrease in these mechanical properties on increasing CaCl₂ addition (A and B). Cohesiveness appears to decrease at CaCl₂ concentrations of 9.8 mM and increase as concentrations decrease or increase around this value.

TABLE 22
Description of the visual characteristics of the oleogels before
and after being subjected to pan searing for 3 minutes.

| CaCl₂ | | |
|---|---|---|
| Conc. | | |
| (mM) | Pre Cooking | Post Cooking |
| 4.9 | Soft, slightly elastic gel | Structure does not survive |
| | which fractures when | cooking. High oil release |
| | lightly compressed. Light, | and the formation of a crisp |
| | creamy texture. | protein film. |
| 9.8 | Highly elastic gel which | Structure maintained during |
| | fractures when compressed. | cooking. Forms a crisp |
| | Creamy interior texture | protein film and a soft gel |
| | but quite brittle. | structure on top of the of |
| | | the seared face. |
| 14.71 | Grainy textured gel. Little | Structure is well maintained |
| | elasticity but flows when | in the searing process. Forms |
| | compressed. | a thin, crisp film on the |
| | | surface of the oleogel. |
| 19.60 | A grainy, non-elastic gel | Structure is well maintained |
| | is formed. The gel lacks | during the searing process. |
| | structure and is similar | Forms a thin, crispy film |
| | to a soft cheese. | on the surface of the oleogel. |

### Discussion

Changes to the ionic environment of the oleogels did not cause predictable differences to the gel's mechanical properties. Rather, the maxima and minima were found in the hardness, modulus and cohesiveness of the gel as amount of CaCl₂ increased.

The results suggest that the gellan gum network is the main driver of the mechanical properties of the oleogel. The heat stability of the gels seemed to be related to the amount of CaCl₂ present in the systems too, with increasing ionic concentration resulting in increasing structure after cooking. This may be related to the strength of the gellan gum network formed till a critical CaCl₂ is reached. However, after that critical point, the gellan gum network does not dictate the thermal stability of the oleogel any longer. This would suggest that the heat stability may be related to the changes in the soy protein network or the soy proteins that are bound at the interface. Increasing the concentration of positively charged ions in the system reduces electrostatic repulsion between the negatively charged soy proteins. This would allow the proteins to pack more tightly, resulting in a thicker interface providing more stability when subjected to thermal treatment.

A systematic error to be noted in this experiment can be found in the measurement of the young's modulus. At the beginning of the stress-strain curves, the gels are within the margin of error of the measurement tool (±0.05N). This, along with the uneven surface of the gel, causes a large amount of variation in the results which may not be representative of the true modulus of the gels.

### Conclusion and Recommendations

The hardness, modulus and cohesiveness of the gel may all affected by the amount of cations present in the oleogel system. This appears to follow trends seen by single phase gellan gum systems. The thermal stability of the oleogels may also be dependent on the amount of ions present in the system. Thus, the ionic concentration of the oleogel may be controlled in order to create a texture that is mechanically sound but also thermally stable. It would be recommended to examine more narrow concentrations of CaCl₂ between 5-15 mM in order to more clearly define where the mechanical properties of the oleogel plateau. Further, examining the effect of other common ions in food, such as KCl and NaCl, may be beneficial.

### 9. Effect of Dispersed Phase Droplet Size on Emulsion Viscosity and Subsequent Mechanical Properties of the Oleogels

The oil droplets in the current oleogel formulation are stabilized by pea proteins that are chemically crosslinked by transglutaminase, making them bound particles (or active fillers) in the gel system. Understanding how these droplets affect the macroscopic deformation of the oleogel would then be an important in tailoring its mechanical properties. Thus, the main aim of this experiment is to observe what effect emulsion droplet size has on the mechanical properties of the oleogel.

### Materials and Methods

8 wt % of pea protein isolate was dispersed into demi water using an ultraturrax. Low and high acyl gellan gum solutions of 2.4 wt % were prepared by dissolving the polymers into hot (95° C.) water using an ultraturrax.

To prepare the emulsions, sunflower oil was dispersed into the PPI dispersion using the ultraturrax. Large, medium and small droplets were created by using speeds corresponding the 20, 30 and 40% power on the ultraturrax. All emulsions were homogenized at the given speed for 3 minutes. Following the emulsion formation, the emulsion was heated to 60° C. in a water bath. The required amount of LAGG and HAGG was then added and homogenized using the ultraturrax set to the speed used to form the emulsion. 1 mL of 0.5M CaCal₂ was then added followed by 1 mL of 10% mTgase when the temperature was <60° C. The oleogels were then cooled to 5° C. for 1 hour followed by incubation at 40° C. for 2 hours. The oleogels were then cut into 15×20 mm cylinders for texture analysis by TPA.

### Microscopy

Sample emulsions were diluted with demi water before imaging was performed. After dilution, 1 drop of emulsion was placed onto a slide, fixed with a coverslip and placed onto the microscope (Olympus CHB). Images were taken at 500× magnification. A ruler imaged at the same magnification was used to calibrate the sizes. Images were then analyzed using ImageJ (NIH, 2020). Briefly, the images were cropped to 1000×1000 pixel squares. A black-white threshold (70-255) was applied and from this data the area and number of the droplets in each image was measured.

### Results

The experiments show that the median droplet area for the higher ultraturrax speed (v40) was 17.18 μm² while that of the lower ultraturrax speed was 31.77 μm². Both the low and high ultraturrax speeds resulted in polydisperse distributions, but with differences in the major peaks in are of the particles. The higher speed resulted in a major peak in droplets at 0-2.5 μm² while the lower speed resulted in a major peak of droplets at 5-10 μm².

Results of the mechanical properties of the oleogel are presented in Table 23. Hardness of the oleogels was shown to increase with increasing ultraturrax speed and thus decreasing droplet size. The modulus of the oleogels was also shown to increase but with a weaker relationship than that of the hardness. The cohesiveness of the oleogels may not be affected by the size of the droplets present within the system.

TABLE 23
Effect of the ultraturrax speed on the modulus
and cohesiveness of the oleogels.

| | v20 | v30 | v40 | |
|---|---|---|---|---|
| Modulus | 0.52 (0.1) | 0.54 (0.2) | 0.68 | (0.1) |
| Cohesiveness | 0.26 (0.0) | 0.34 (0.1) | 0.2 | (0.0) |

### Discussion

Altering the speed of the ultraturrax was shown to impact the distribution of the droplets within the oleogel. This change in droplet distribution as a result of increased shear speed of the ultraturrax translated in changes to the mechanical properties of the oleogel, which was especially true when considering the hardness of the oleogels. This is suggested to be due to the higher surface-area to volume ratio of the smaller, resulting in closer droplet packing and more overall interactions between the droplet surface proteins. The higher surface area may therefore contribute to greater opportunity for the surface crosslinking of the pea proteins by the transglutaminase, which may result in a harder gel structure with an increased young's modulus.

It may be relevant to consider selecting droplet size depending on the application of the oleogel produced in this experiment. For a high oil release, it may be necessary to increase the emulsion droplet size while a smaller droplet size could be used for a more controlled release.

As no ultraturrax speeds or homogenization times were reported in previous experimentation, this experiment highlights a systematic error in the reported protocols. Though during previous experiments care was taken to use the same speed on the ultraturrax (v30), the impact of the droplet size distribution was not considered to be of as great important as was presented in this experiment. Thus, for further experimentation and protocols, the speed of the ultraturrax and time of homogenization will be reported. It is also important to note that a fairly imprecise method was used to determine the size of the droplets. However, the method allows for qualitative differences between the droplets to be discerned as magnification of the slide was not changed. Thus, the reported areas of the droplet sizes should not be taken verbatim but with an understanding that there is a degree of inaccuracy. It is interesting to note that the main differences in droplet sizes occurred in the smaller size distributions while the larger droplets were similarly distributed. This may be either a result of instability phenomena occurring within the emulsions (e.g. coalescence) that are occurring at the same rate or as a result of the image analysis software method.

### Conclusion and Recommendations

The observation that homogenization speed alters the distribution of the droplet size of the emulsion may be an important parameter to consider for process scale up. As a result of this, the production of this type of oleogel with an increased hardness would then benefit from high homogenization speeds. This may be a challenge when moving from producing 100 mL of oleogel using the ultraturrax to 1000 mL of oleogel using a standard piece of kitchen equipment such as a handblender.

### 10. Effect of Coconut Oil Addition on the Mechanical Properties of Reformulated Oleogel

Results of previous experiments showed that the addition of solid fat to the formulation of the oleogel resulted in increased hardness. The previous experiments were performed within the HPMC-gellan gum matrix and not within the PPI-gellan gum matrix. Coconut oil was chosen as a solid fat source due to its consumer acceptability low sustainability issues. The aim of this experiment is to determine how varying the amount of coconut oil would alter the mechanical and culinary properties of the oleogel.

### Materials and Methods

8 wt % pea protein isolate was dispersed into deionized water using an ultraturrax. 2.4 wt % solutions of low and high acyl gellan gums were created by dissolving the gums in hot (95° C.) water by means of an ultraturrax. Coconut oil was added to sunflower oil in varying quantities (Table 24), heated to 95° C. and gently shaken to homogenize the oils.

Each fat blend was then emulsified into the pea protein isolate dispersion by using the ultraturrax set to 30% for 3 minutes. The emulsions were then heated to 60° C. followed by the addition of the hot low and high acyl gellan gum solutions. 1 mL 0.5M CaCl₂ was then added to the polymer dispersion followed by 1 mL 10 wt % mTgase solution when the temperature of the dispersion was between 55-60° C. The oleogels were then placed into molds and cooled at 5° C. for 12 hours. Follow this, the oleogels were incubated at 40° C. for 2 hours followed by drying for 2 hours at 40° C. Samples were taken from the oleogels before and after drying for analysis by TPA.

TABLE 24
Ratio of coconut oil added to each oleogel.

| Coconut oil (%) | 0 | 5 | 10 | 20 |
|---|---|---|---|---|
| Sunflower oil (g) | 50 | 44.9 | 39.8 | 29.6 |
| Coconut oil (g) | 0 | 5.1 | 10.2 | 20.4 |

### Results

Prior to drying, the results show that before drying the hardness, modulus and cohesiveness of the oleogels were not greatly altered by the amount of coconut oil added. After drying, ring of oil could be seen on the paper of the 20% coconut fat sample. This was also somewhat visible on the 10% sample but not present on the 5 or 0% coconut oil samples. Drying caused a large increase in the hardness of the samples, with the hardness increasing correlatively with the amount of coconut oil in the samples. This same trend was also seen for the modulus of the oleogels. The cohesiveness did not appear to be altered by the amount of coconut fat present within the oleogel.

### Discussion

The addition of a portion of solid fat to the oleogel formulation appeared to have little effect before drying but a pronounced effect after drying took place when coconut fat was greater than 10%. The effect of drying on the oleogel hardness was seen in previous experiments and was suggested to be due to the continuous phase acting as an inactive filler, hindering fat crystal network formation. The presence of a small amount of coconut oil (<10%) did not seem to increase the hardness. This could perhaps be due to there not being enough solid fat within the coconut oil to form another space-spanning network within the oleogel.

During the drying process, a ring of fat could be seen surrounding the 20 and 10% samples but not the 5 and 0% samples. Since the drying occurs at temperatures exceeding the melting point of coconut fat, it was suggested that this fat was the coconut fat phase separating from the oleogels. This would firstly suggest that the amount of fat present in the 10 and 20% samples was in fact lower than those reported here.

### Conclusion and Recommendations

This experiment suggests that the overall hardness of the oleogels could be approximately doubled by adding in between 10 and 20% coconut fat to the oleogel recipe. This hardening is highly temperature dependent and the coconut fat is likely to phase separate from the oleogel during the drying process. Keeping in mind the previous experimentation on solid fat content, it may be wise to consider using fats with a higher solid fat content than coconut fat.

11. Effect of incubation and drying time on the mechanical properties of the oleogel

The production of the oleogel may include an incubation step in order to have the microbial transglutaminase crosslink the protein. Following this, a drying step is used to concentrate the fat by evaporating water from the oleogel. So far, it has been shown that the addition and incubation of mTgase within the oleogel may influence thermal stability (experiment 5). Similarly, the drying process appeared to improve the mechanical properties and thermal stability of the oleogel. However, the extent to which these processes affect the oleogel system have so far not been studied. Thus, the aim of this experiment is the document how changing the incubation and drying times affect the mechanical properties of the oleogel.

### Materials and Methods

An oleogel was prepared using the ingredients and ratios shown in Table 25. Firstly, an emulsion was formed between the 8 wt % PPI and the sunflower oil using the ultraturrax set to speed 40. Following this, the emulsion was heated by means of a water bath to 70° C. The hot (95° C.) LAGG and HAGG were then added to the hot (70° C.) emulsion and mixed together using a hand blender. Following this, the 0.5M CaCl₂ solution was then added. The mixture was cooled to below 60° C. and the 10 wt % mTgase was added. The dispersion was then poured into a mold and allowed to cool to 5° C. Following this, cylindrical samples (diameter=20 mm, height=20 mm) were cut from the mold.

Samples were placed into a sealed container and incubated for 1, 2, 4 and 24 hours at 40° C. in an incubation oven. To test the effect of drying on the mechanical properties of the oleogel, samples were all first incubated for 2 hours at 40° C. Following this, the sample container was unsealed and the oleogels were dried for 0, 2, 4 and 24 hours. Before texture analysis, the samples were placed in the refrigerator for at least 2 hours to ensure that they were all at the same temperature.

TABLE 25
Ingredients and proportions used for the manufacturing of the
oleogels used to test the effect of drying and incubation time.

| Ingredient | Mass (g) | |
|---|---|---|
| 2.4 wt % LAGG | 75 | 14.0% |
| 2.4 wt % HAGG | 75 | 14.0% |
| 8 wt % PPI | 125 | 23.4% |
| 0.5M CaCl2 | 5 | 0.9% |
| 10 wt % mTgase | 5 | 0.9% |
| Sunflower oil | 250 | 46.7% |
| Total | 535 | |

### Results

Hardness, modulus and fracture strain all showed a slight increase over the course of 24 hours of incubation. Cohesiveness did not show any large changes as a result of the incubation times. The largest change in the mechanical properties occurred with the fracture strain of the samples, which increased from 0.36 to 0.41 over the course of a 24 hour period of incubation.

Drying of the samples at 40° C. resulted in an increase in the number of total solids of the oleogels from 49.4% to 82.3%. The mechanical properties of the oleogel showed a large amount of change as a result of the loss of moisture. Hardness increased from 10.4 to 38.2N and the modulus of the gels increased from 0.51 to 1.67 Pa after 24 hours of drying. The fracture strains and cohesiveness of the oleogels were affected by the drying too, with both showing an increase in their values over the course of the drying period. The results of the TPA test are presented in Table 26.

TABLE 26
TPA results for the mechanical properties of the oleogel during drying.
Results are presented as means (±standard deviation; n = 2).

| Time (hours) | 0 | 2 | | 4 | | 24 | |
|---|---|---|---|---|---|---|---|
| Hardness (N) | 10.4 (0.69) | 13.24 | (0.88) | 17.26 | (2.16) | 38.20 | (2.50) |
| Modulus (Pa) | 0.51 (0.05) | 0.59 | (0.06) | 0.57 | (0.16) | 1.67 | (0.12) |
| Fracture Strain | 0.34 (0.01) | 0.35 | (0.02) | 0.37 | (0.04) | 0.40 | (0.01) |
| Cohesiveness | 0.16 (0.01) | 0.21 | (0.02) | 0.18 | (0.04) | 0.29 | (0.01) |

### Discussion

Overall, the incubation may have little effect on the mechanical properties of the oleogel. Though some mechanical parameters were shown to increase over time (such as hardness and fracture strain). From a processing point of view, this means that a short incubation period is sufficient in order to gain the thermal stabilizing effects of the transglutaminase linked network. The short time required could be related to the excess of mTgase added to the oleogels as no testing so far has focused on optimizing the amount needed for the oleogel.

The dehydration of the oleogels may have a much greater impact on their mechanical properties. This can be seen by Table 26 where increasing the amount of time dehydrating at 40° C. resulted in an increase in all mechanical parameters measured. The decrease in the water content resulted in an increase in the concentration of the dissolved polymers, which may result in an increase in the hardness and modulus of the oleogels, as shown before. Further, the cross-linked and stabilized protein oil-water interface resisted emulsion droplet coalescence and maintained its structure. It would then be possible to use dehydration as a parameter that could be relatively easily tuned to the properties needed for the oleogels application.

### Conclusion and Recommendations

This experiment aimed to explore how changing the incubation and dehydration times can affect the mechanical properties of the oleogel. The incubation time may have little effect while changing the drying time may cause a lot of variation in the mechanical properties.. Drying on the other hand hay have a large effect on the mechanical properties. Thus, it may be possible to tune the drying behavior depending on what is trying to be emulated.

### Overall Conclusion and Recommendations

The structuring of liquid oil using plant based proteins in combination with a bond-forming polysaccharide was shown to be possible by sequential gelation of the polymers. The properties of the formed material were found to be similar to that of beef adipose tissue with exception to the young's modulus. Methods for altering the young's modulus are suggested based on the amount of solid fat present within the oleogel (Table 27).

At present, the analogue has only been shown to function as a stand-alone material. However, it does show some practical applications. Firstly, The analogous material could be used as a component within novel meat analogues that intend to mimic whole muscle tissue. This could either be as muscle tissue marbling or as a intermuscular fat, such as the fat-cap on a ribeye steak. For this application, the good heat stability seen during pan frying would be useful. Secondly, the material could be used as pork fat back is used inside of sausage analogues. For this, the elasticity and high fracture point would make it able to withstand the mechanical work of a meat grinding. Furthermore, the possibility to tune its fat stability based on its physiochemical composition would perhaps be useful in making sausage analogues more juicy. Finally, the composition of the material presents many new opportunities as a novel texture in food.

TABLE 27
Summary of experimental results and their roles in affecting the mechanical properties
of the oleogels studied. Especially, from the experimental data, these may be the
parameters within the oleogel that can be tweaked to provide different outcomes.

| Factor | Effect | Experiment |
|---|---|---|
| LAGG:HAGG ratio | ¹For increasing ratio, linear increases are seen in: | 4 |
| | 1. Hardness | |
| | 2. Cohesiveness | |
| GG Concentration | ²1:1 LAGG:HAGG, 0 wt %-2.4 wt %: | 6 |
| | 1. Hardness increases (1-10N) | |
| | 2. Modulus increases (0.05-0.4 Pa) | |
| CaCl₂ concentration | ²CaCl₂ conc. 4.9 mM-19.60 mM: | 8 |
| | 1. Max. modulus at 10 mM (0.15 Pa) | |
| | 2. Max. hardness at 10 mM (2N) | |
| | 3. Max cohesiveness at 19.6 mM (0.45) | |
| mTgase presence | ²Crosslinking supports the formation | 5 |
| | of a thermally stable gel. | |
| Drying (40° C.) | ²Drying time (0-24 hours): | 11 |
| | 1. Increases hardness (10-38N) | |
| | 2. Increases modulus (0.51-1.67 Pa) | |
| | 3. Increases fracture strain (0.34-0.4) | |
| | 4. Increases cohesiveness (0.16-0.29) | |
| Incubation (40° C.) | ²Little effect after 1 hour of incubation. | 11 |
| Droplet size | decreasing droplet size (17-32 μm²): | 10 |
| | 1. Increases hardness (4-6N) | |
| | 2. Increases modulus (0.5-0.7 Pa) | |
| Solid fat content | increasing SFC (7.3%-29.2%; t = 20° C.): | 3; 10 |
| (SFC) | 1. Increases hardness (1-4.5N) | |
| | 2. Increases modulus (0.05-0.2 Pa) | |
| | The type of fat incorporated greatly affects the | |
| | overall rate of hardness and modulus increase. | |

Superscripts denote the matrix in which the effect was studied: ¹2.4 wt % HPMC, 1:1 LAGG [2.4 wt %]:HAGG[2.4 wt %]; ²8 wt % P/SPI, 1:1 LAGG [2.4 wt %]:HAGG[2.4 wt %].

### Further Experiments

In the initial experiments, the gelation of the proteins and polysaccharides has especially been performed using direction addition of crosslinking agents, calcium chloride and microbial transglutaminase. Both may need to be added at specific temperatures where there is little overlap. Due to the high water activity of gellan gum gels, components may optionally also diffuse in and out of the gel. This experiment aimed to test this hypothesis at 2 concentrations of calcium chloride; 0.5M and 0.05M Materials and Method

| Ingredient | % | grams |
|---|---|---|
| Dispersed phase (sunflower oil) | 61.72% | 617.17 |
| Continuous phase (see below) | 38.28% | 382.83 |
| Total | 100% | 1000.00 |

| Continuous phase | % Rel. | g |
|---|---|---|
| Unisol GP | 5.00% | 19.14 |
| Kelcogel Gellan F | 0.70% | 2.68 |
| Kelcogel Gellan LT 100 | 0.10% | 0.38 |
| Sodium citrate | 0.20% | 0.76 |
| Sodium chloride | 0.29% | 1.11 |
| Water | 31.99% | 358.76 |

| Bath 1; 0.05M, MT+ | % | g |
|---|---|---|
| Calcium chloride | 0.56% | 5.60 |
| Microbial Transglutaminase | 0.002 | 2.00 |
| Water | 99.24% | 992.40 |

| Bath 2; 0.5M, MT+ | % | g |
|---|---|---|
| Calcium chloride | 5.56% | 55.60 |
| Microbial Transglutaminase | 0.002 | 2.00 |
| Water | 94.24% | 942.40 |

| Bath 3; 0.5M, MT+ | % | g |
|---|---|---|
| Calcium chloride | 5.56% | 55.60 |
| Water | 94.24% | 944.40 |

| Bath 4; 0.5M, MT− | % | g |
|---|---|---|
| Calcium chloride | 5.56% | 5.60 |
| Water | 94.24% | 994.40 |

### Bath:

1. Combine the calcium chloride and transglutaminase with the water.
2. Blend to dissolve.
3. Heat to 55° C. in a water bath.
   TVF (Texturized vegetable fat) recipe:
1. Combine the sodium citrate, sodium chloride and water. Mix till dissolved.
2. Dry blend the unisol GP, Gellan F and Gellan LT 100.
3. Disperse into the water.
4. Blend at room temperature for 5 minutes.
5. Heat the 90° C. for 15 minutes.
6. Slowly add the oil in at 90° C. This step takes approximately 5 minutes for 1 kg of product.
7. Pour the oleogel into a mould and allow to set at room temperature.
8. Cut into cubes and place into the 55° C. water bath for 1 hour.
9. Cool in the refrigerator.
10. The samples were then fried and single penetration TA was performed on the gel cubes.

### Results

The viscosity of the initial hydrated protein and polysaccharide mixture (steps 3 and 4) appears to be (much) lower than in the initial experiments. This may relate to the addition of sodium chloride which reduces the viscosity of hydrated gellan gum dispersions.
The reduced viscosity makes dispersion of the soy protein isolate easier.
During the protein hydration and denaturation steps (step 4-5), there was no foaming of the dispersion.
Emulsion formation proceeds as normal compared to the initial experiments.
Setting of the gel into molds (step 7) is much less prone to setting at an undesired time without the addition of the cross-linking agents.
The gel remains submerged in the bath but may be flipped over or stirred to ensure adequate diffusion of calcium and enzyme into the product.
After 1 hour of incubation, all gel samples appeared to be physically harder.
Frying the samples showed that all were heat stable, regardless of presence of enzyme or quantity of calcium chloride in the water bath.
The bath CaCl₂ concentration appears to have a large effect on the fracture stress and strain of the samples, while the addition of microbial transglutaminase does not have such a large affect.
Using 5M CaCl₂ gives a fracture stress of approximately 10N and a fracture strain of approximately 32% while 0.5M CaCl₂ results in a lower fracture stress (approx. 6N) and a higher fracture strain (40%).

### Conclusion

The use of an indirect method of cross linking appears to provide a more robust process for the production of TVF.
The properties of the gel can be altered by changing the amount of calcium chloride in the bath.
A 1 hour incubation time at 50° C. was chosen arbitrarily; Experiments should be performed to see if the time of incubation affects the gel structure.
A long incubation at lower temperature with an 0.5M CaCl₂ bath also works. However, after 8 hours refrigerated, the samples had a bitter taste. Perhaps from too much CaCl₂),
It is not known yet if transglutaminase is required if an indirect method of calcium addition is used.

1. A method for producing an oleogel, the method comprising a mixing stage and a cross-linking stage; wherein:
the mixing stage comprises mixing starting materials to provide a starting mixture, wherein the starting materials comprise (i) a hydrocolloid, (ii) a protein, (iii) one or more of a fat and an oil, and (iv) water, wherein the protein is a vegetable based protein and wherein the one or more of the fat and the oil is a vegetable based; and
the cross-linking stage comprises cross-linking the hydrocolloid and the protein in the starting mixture, to provide a cross-linked structure;
wherein the oleogel comprises the cross-linked structure, wherein the oleogel comprises a total amount of fat and oil relative to a total amount of the oleogel in the range of 20-90 wt. %.

2. The method according to claim 1, wherein the mixing stage comprises an initial mixing stage and an emulsification stage; wherein
the initial mixing stage comprises mixing the hydrocolloid, the protein and the water to provide an initial starting mixture, and
the emulsification stage comprises emulsifying the one or more of the fat and the oil into the initial starting mixture, wherein the starting mixture comprises an emulsion.

3. The method according to claim 2, wherein the starting materials further comprise a sequestering agent, wherein the initial mixing stage comprises mixing the hydrocolloid, the protein, the sequestering agent, and the water to provide the initial starting mixture.

4. The method according to claim 1, further comprising a setting stage configured between the mixing stage and the cross-linking stage, wherein the setting stage comprises cooling the starting mixture to a setting cooling temperature to provide a set starting mixture, wherein the setting cooling temperature is 40° C. at maximum.

5. The method according to claim 4, further comprising cooling the starting mixture in a mold.

6. The method according to claim 4, wherein the method further comprises a cutting stage between the setting stage and the cross-linking stage, wherein the cutting stage comprises reducing a dimension of the set starting mixture, wherein the dimension is reduced to 0.5-5 cm.

7. The method according to claim 1, wherein the cross-linking stage comprises providing a hydrocolloid cross-linker and a cross-linking enzyme to the starting mixture for cross-linking the hydrocolloid and the protein in the starting mixture.

8. The method according to claim 7, wherein the cross-linking stage comprises:
contacting the starting mixture, with a cross-linker solution, wherein the cross-linker solution comprises the cross-linking enzyme and the hydrocolloid cross-linker, and
diffusing the cross-linking enzyme and the hydrocolloid cross-linker in the starting mixture, to cross-link the protein and the hydrocolloid.

9. The method according to claim 8, wherein contacting the starting mixture with the cross-linker solution comprises immersing the starting mixture in the cross-linker solution; and wherein the cross-linking stage comprises maintaining a temperature of the starting mixture at an incubating temperature during a cross-linking incubation period, wherein the incubating temperature is selected from the range of 40-60° C.; and wherein the cross-linking incubation period is 30 min-4 hours.

10. The method according to claim 7, wherein the hydrocolloid cross-linker comprises a salt comprising one or more cations from the group consisting of (i) calcium, (ii) potassium, (iii) sodium, and (iv) magnesium and the cross-linking enzyme comprises transglutaminase.

11. (canceled)

12. (canceled)

13. The method according to claim 1, wherein the protein comprises a protein isolate.

14. The method according to claim 1, wherein the protein comprises one or more proteins of the group consisting of (i) pea protein, (ii) soy protein, (iii) lupine protein, (iv) chickpea protein, (v) wheat protein, (vi) oat protein, (vii) potato protein, (viii) flax protein, (ix) hemp protein, (x) corn protein, (xi) barley protein, (xii) rye protein, (xiii) bean protein, (xiv) spirulina protein, (xv) canola protein, (xvi) faba bean protein, (xvii) mung bean protein, (xviii) navy bean protein, (xiv) rice protein, (xv) mycoprotein, and (xvi) algae protein.

15. The method according to claim 1, wherein the one or more of the fat and oil comprise one or more of the group consisting of (i) palm fat, (ii) coconut fat, (iii) cacao fat, (iv) sunflower oil, (v) olive oil, (vi) rapeseed oil, (vii) soy oil, (viii) peanut oil, and (ix) rice bran oil.

16. The method according to claim 1, wherein the hydrocolloid comprises one or more of the group consisting of (i) gellan gum, (ii) agar agar, (iii) xanthan, (iv) pectin, (v) sodium alginate, (vi) gelatin, (vii) locust bean gum, (viii) flaxseed gum, (ix) guar gum, (x) carboxy methyl cellulose, (xi) gum Arabic, (xii) carrageenan, and (xiii) methyl cellulose.

17. The method according to claim 1, wherein the hydrocolloid comprises gellan gum comprising low-acyl gellan gum and high-acyl gellan gum, wherein the high-acyl gellan gum comprises a degree of acylation over 50% and the low-acyl gellan gum comprises a degree of acylation lower than 50%; wherein a weight ratio of the low-acyl gellan gum to the high-acyl gellan is selected from the range of 1:10-10:1.

18. The method according to claim 1, wherein a total weight of hydrocolloid in the starting mixture is selected in the range of 0.01-5 wt. % relative to a total weight of the starting mixture, and wherein a total weight of protein in the starting mixture is selected in the range of 0.5-10 wt. % relative to a total weight of the starting mixture.

19. An oleogel comprising a cross-linked protein and a cross-linked hydrocolloid, and one or more of a fat and oil, wherein the protein is vegetable based and wherein the one or more of the fat and oil is vegetable based, wherein the oleogel comprises an oil and fat content in the range of 20-90 wt. %, wherein the oleogel substantially maintains its shape when being heated to a temperature of 100° C.

20. (canceled)

21. A food product comprising the oleogel according to claim 19.

22. The food product according to claim 21, wherein the food product is a vegan analog for meat.

23. The method according to claim 1, further comprising:
a drying stage wherein the drying stage comprises drying the cross-linked structure to provide a further processed cross-linked structure.
